(19) United States
(12) Patent Application Publication
(10) Pub. No.: US 2014/0295183 A1
(43) Pub. Date: Oct. 2, 2014

(54) PRESSURE-SENSITIVE ADHESIVE COMPOSITION, PRESSURE-SENSITIVE ADHESIVE SHEET AND OPTICAL FILM

(71) Applicant: NITTO DENKO CORPORATION, Osaka (JP)

(72) Inventors: Masato Yamagata, OSAKA (JP); Masayuki Okamoto, OSAKA (JP)

(73) Assignee: NITTO DENKO CORPORATION, Osaka (JP)

(21) Appl. No.: 14/227,157

(22) Filed: Mar. 27, 2014

(30) Foreign Application Priority Data
Mar. 28, 2013 (JP) 2013-069793

(51) Int. Cl. C09J 7/02; G02B 1/04

(52) U.S. Cl. CPC C09J 7/0217; G02B 1/04
USPC 428/355 CN; 525/200

(57) ABSTRACT

Provided are a pressure-sensitive adhesive sheet that has an antistatic property; suppresses a peeling electrification voltage when a non-antistatic treated adherend is peeled off; has a small adhesive strength occurring at high-speed peeling; has an adhesive strength occurring at low-speed peeling so large as not to cause a problem, such as lifting and peeling off; and has an excellent transparency; and a pressure-sensitive adhesive composition capable of obtaining an optical film to which the pressure-sensitive adhesive sheet is bonded. Disclosed is a pressure-sensitive adhesive composition containing a polymer (A) having a glass transition temperature of lower than 0° C. and a polymer (B) containing a reactive ionic liquid as a monomer unit and having an intrinsic viscosity (dL/g) of 0.01 or more and less than 0.5.

### BACKGROUND OF THE INVENTION

1. Field of the Invention

The present invention relates to a pressure-sensitive adhesive composition having an antistatic property, a pressure-sensitive adhesive sheet made into the form of a sheet or a tape using the composition, and an optical film with the pressure-sensitive adhesive sheet.

A pressure-sensitive adhesive sheet formed from the pressure-sensitive adhesive composition having an antistatic property of the present invention is suitably used in plastic products on which static electricity is easily generated. Above all, such a sheet is particularly useful as an antistatic pressure-sensitive adhesive sheet for use in electronic instruments that should avoid static electricity, as well as useful as a surface protecting film used for the purpose of protecting the surface of optical members, such as polarizing plates, wavelength plates, optical compensation films, reflective sheets, and the like.

2. Description of the Related Art

In general, such a surface protective film is bonded to an object to be protected (adherend) with a pressure-sensitive adhesive therebetween that is provided on the protective film side, and used to prevent scratching or staining during the processing or feeding step of the object. For example, a liquid crystal display panel is formed by bonding optical components such as polarizing plates and wavelength plates to a liquid crystal cell, with an adhesive therebetween. The protective films for the purpose of preventing scratching or staining are bonded to the optical components to be bonded to the liquid crystal cell, with a pressure-sensitive adhesive therebetween.

Then, the protective film is removed by peeling off at the stage when the protective film becomes unnecessary, for example, when this optical member is bonded to the liquid crystal cell. Generally, the protective film and the optical member are composed of plastic materials, so that electrical insulating property is high and static electricity is caused during friction and peeling off. Therefore, when the protective films are peeled from the optical components such as polarizing plates, static electricity is generated. If the generated static electricity remains when voltage is applied to the liquid crystal, the liquid crystal molecule can be out of alignment, or the panel can be damaged. Thus, in order to prevent such defects, various antistatic treatments are applied to the surface protective film.

For example, there is disclosed a method where one or more surfactants are added to a pressure-sensitive adhesive and the surfactant from the pressure-sensitive adhesive is transferred to an adherend, thereby to prevent the generation of static electricity (see, for example, Patent Document 1). In this technique, however, the surfactant easily bleeds out from the pressure-sensitive adhesive to its surface, and when it is applied to a protective film, there is a risk of staining to the adherend. Accordingly, when a pressure-sensitive adhesive containing a low-molecular weight surfactant is applied to a protective film for optical components, sufficient antistatic properties are difficult to be developed without degradation of optical properties of the optical components.

In addition, a method of adding an antistatic agent composed of a polyether polyol and an alkali metal salt to an acrylic pressure-sensitive adhesive to prevent the antistatic agent from bleeding on the surface of the pressure-sensitive adhesive is disclosed (for example, see Patent Document 2). However, bleeding of the antistatic agent cannot also be avoided even in this method; consequently, in the case of actually applying the pressure-sensitive adhesive to the surface protective film, treatment under high temperatures causes staining on the adherend due to the bleeding phenomenon.

There is also disclosed a technology relating to an antistatic acrylic pressure-sensitive adhesive containing an ionic compound and an acryl-based copolymer having an alkylene oxide chain in the side chain, by which antistatic properties and low staining properties are simultaneously achieved (Patent Document 3). Unfortunately, this technique may cause a problem such as lifting or peeling off.

In addition, there is disclosed a method of adding an acryl-based copolymer containing a quaternary ammonium group in the side chain as an antistatic agent to an acryl-based pressure-sensitive adhesive, by which low staining properties and antistatic properties are simultaneously achieved (Patent Document 4). However, as an alkylating agent for quaternizing the side chain of the acryl-based copolymer, dimethyl sulfate and diethyl sulfate, which are highly carcinogenic and toxic, are used. Thus, the method has a problem that the pressure-sensitive adhesive might adversely affect a human body if the alkylating agent remains therein.

As stated above, a surface protecting film is peeled off and removed when it becomes unnecessary, and in this case, the film is mostly peeled off at relatively high speed from the viewpoint of work efficiency. Accordingly, there is a problem that if the adhesive strength occurring at high-speed peeling is large, work efficiency is decreased and an object to be protected, such as an optical member, glass, or the like, may be damaged while the film is being peeled off. On the other hand, when the adhesive strength occurring at high-speed peeling is made to be sufficiently small, there is sometimes a problem that lifting and peeling off of the film may occur after the punching process of an object to be protected or the polishing process of the end surface of the object. In addition, when a surface protecting film is used for protecting the surface of an optical member, there are sometimes the cases where inspection of an adherend is performed while the surface protecting film is being bonded thereto, and accordingly, there is a demand that the surface protecting film itself has high transparency.

### PRIOR ART DOCUMENTS

### Patent Documents

Patent Document 1: JP-A-9-165460

Patent Document 2: JP-A-6-128539

Patent Document 3: JP-A-2005-206776

Patent Document 4: JP-A-2010-126707

### SUMMARY OF THE INVENTION

Therefore, in light of the circumstances described above, an object of the present invention is to provide a pressure-sensitive adhesive composition which is capable of preventing electrification at the time of peeling off of a non-antistatic treated adherend and suppressing peeling electrification voltage; has a small adhesive strength at high-speed peeling; has a high adhesive strength at low-speed peeling, to the degree enough not to cause problems such as lifting or peeling off; and is excellent in transparency; to provide an antistatic pressure-sensitive sheet using the pressure-sensitive adhesive composition; and to provide an optical film with the pressure-sensitive adhesive sheet.

That is, the pressure-sensitive adhesive composition of the present invention contains a polymer (A) having a glass transition temperature of lower than 0° C. and a polymer (B) containing a reactive ionic liquid as a monomer unit and having an intrinsic viscosity (dL/g) of 0.01 or more and less than 0.5.

In the pressure-sensitive adhesive composition of the present invention, 0.05 to 30 parts by mass of the polymer (B) is preferably contained based on 100 parts by mass of the polymer (A).

In the pressure-sensitive adhesive composition of the present invention, the polymer (B) is preferably a (meth)acryl-based polymer.

In the pressure-sensitive adhesive composition of the present invention, the polymer (B) contains preferably a monomer having a polyoxyalkylene skeleton as a monomer unit.

In the pressure-sensitive adhesive composition of the present invention, the reactive ionic liquid is preferably one represented by the following general formula (1) and/or (2):

CH₂═C(R¹)COOZX⁺Y⁻ (1)

CH₂═C(R¹)CONHZX⁺Y⁻ (2)

[In the formulae (1) and (2), R¹ is a hydrogen atom or a methyl group, X⁺ is a cation moiety, and Y⁻ is an anion. Z represents an alkylene group of 1 to 3 carbon atoms.)

In the pressure-sensitive adhesive composition of the present invention, the cation moiety is preferably a quaternary ammonium group.

In the pressure-sensitive adhesive composition of the present invention, the anion is preferably a fluorine-containing anion.

In the pressure-sensitive adhesive composition of the present invention, the monomer having a polyoxyalkylene skeleton is preferably an alkylene oxide group-containing reactive monomer having an average addition mole number of 3 to 100 of the oxyalkylene units.

The pressure-sensitive adhesive layer of the present invention is preferably formed from the pressure-sensitive adhesive composition.

The pressure-sensitive adhesive layer of the present invention has preferably a gel fraction of 85.00 to 99.95% by mass.

In the pressure-sensitive adhesive sheet of the present invention, the pressure-sensitive adhesive layer is preferably formed on at least one side of a substrate film.

In the pressure-sensitive adhesive sheet of the present invention, the substrate film is preferably a plastic film.

The pressure-sensitive adhesive sheet of the present invention is preferably used for surface protection.

The pressure-sensitive adhesive sheet of the present invention is preferably used for production process and shipment process of electronic components.

In the optical film with the pressure-sensitive adhesive sheet of the present invention, the pressure-sensitive adhesive sheet is preferably bonded to an optical film.

### BRIEF DESCRIPTION OF THE DRAWINGS

FIG. 1 is a schematic view illustrating a constitution of the pressure-sensitive adhesive sheet.

FIG. 2 is a schematic view illustrating a test on peeling electrification voltage.

### DETAILED DESCRIPTION OF THE PREFERRED EMBODIMENTS

The embodiments of the present invention are described hereinafter in detail.

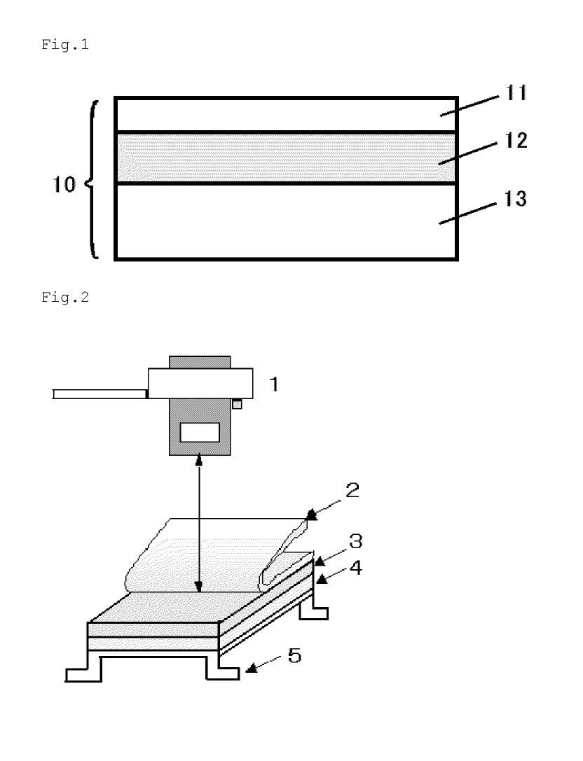

In the pressure-sensitive adhesive sheet of the present invention, a pressure-sensitive adhesive layer is preferably formed on at least one side of a substrate film. As the specific pressure-sensitive adhesive sheet, a typical constitution example is schematically shown in FIG. 1. In the example, a pressure-sensitive adhesive sheet 10 is formed of a substrate film 13 (e.g. polyester film) and a pressure-sensitive adhesive layer 12 provided on one side thereof. The pressure-sensitive adhesive sheet 10 is used by bonding the adhesive layer 12 to an adherend (an object to be protected, e.g. a surface of optical components such as polarizing plate, etc.). As shown in FIG. 1, the pressure-sensitive adhesive sheet before use (i.e. before bonding to the adherend) may be present in a form that the surface (bonding surface to the adherend) of the adhesive layer is protected by a separator 11 having a peeling surface on at least the adhesive layer side. The constitution of the pressure-sensitive adhesive sheet will be explained in detail below.

The pressure-sensitive adhesive composition according to the present invention is characterized by containing a polymer (A) having a glass transition temperature of lower than 0° C. and a polymer (B) containing a reactive ionic liquid as a monomer unit and having an intrinsic viscosity (dL/g) of 0.01 or more and less than 0.5.

Hereinafter, the polymer (A) and polymer (B) will be described in detail.

### [Polymer (A)]

The polymer (A) is not particularly limited, as far as its glass transition temperature is lower than 0° C., and there can be used various polymers that are generally used as pressure-sensitive adhesives, including (meth)acryl-based polymers, rubber-based polymers, silicone-based polymers, polyurethane-based polymers, and polyester-based polymers. In particular, it is preferable to use a (meth)acryl-based polymer that is compatible with the polymer (B) and has high transparency.

The glass transition temperature (Tg) of the polymer (A) is lower than 0° C., preferably lower than −10° C., more preferably lower than −40° C., and usually −80° C. or higher. If the glass transition temperature (Tg) of the polymer (A) is 0° C. or higher, it becomes difficult for the polymer to flow, and the wetting of an adherend becomes insufficient, thereby sometimes the adherability is deteriorated.

When the polymer (A) is a copolymer in the present embodiment, its glass transition temperature is a value calculated based on the equation (3) (Fox equation). Note that the polymer has a meaning to include a homocopolymer (homopolymerized product) and a copolymer (copolymerized product composed of plural monomer components).

1/Tg=W₁/Tg₁+W₂/Tg₂+ . . . +Wₙ/Tgₙ (3)

[In the equation (3), Tg represents a glass transition temperature (unit: K) of a copolymer, Tgᵢ (i=1, 2, . . . , n) represents a glass transition temperature (unit: K) of a homopolymer that is formed of a monomer i, and Wᵢ (i=1, 2, . . . , n) represents amass fraction of the monomer i in the whole monomer components.]

In addition, the glass transition temperatures Tgᵢ of the monomer i are nominal values described in documents (e.g. Polymer Handbook, Adhesive Handbook, etc.), catalogs, and the like.

Herein, the “glass transition temperature of a homopolymer that is formed” means the “glass transition temperature of a homopolymer formed of the monomer”, i.e., means the glass transition temperature (Tg) of a polymer that is formed only of a monomer (sometimes referred to as a “monomer X”) as a monomer component. Specifically, the glass transition temperature (Tg) is described in “Polymer Handbook” (3rd edition, John Wiley & Sons, Inc., 1989).

The glass transition temperature (Tg) of a homopolymer, which is not described in the aforementioned document, means a value obtained, for example, by the following measuring method.

That is, after 100 parts by mass of a monomer X, 0.2 parts by mass of 2,2′-azobisisobutyronitrile, and 200 parts by mass of ethyl acetate as a polymerization solvent are placed into a reactor provided with a thermometer, a stirrer, a nitrogen inlet pipe, and a reflux cooling pipe, they are stirred for 1 hour while nitrogen gas is being introduced. After the oxygen in the polymerization system has been removed in such a way, the mixture is heated to 63° C. and is allowed to react for 10 hours. Subsequently, the mixture is cooled to room temperature to obtain a homopolymer solution having a solid content of 33% by mass. Then, this homopolymer solution is casted and coated onto a release liner, which is then dried to produce a test sample having a thickness of approximately 2 mm (sheet-shaped homopolymer). Approximately 1 to 2 mg of this test sample are weighed into an aluminum open cell, and the Reversing Heat Flow (specific heat component) behaviors of the homopolymer are obtained by using a temperature-modulated DSC (trade name: “Q-2000”, manufactured by TA Instruments) under a nitrogen atmosphere of 50 ml/min and at a rate of temperature increase of 5° C./min.

With reference to JIS-K-7121, the temperature at the point where the straight line which is located in the vertical axis direction at the same distance from both the straight line obtained by extending the base line on the low temperature side of the obtained Reversing Heat Flow and the straight line obtained by extending the base line on the high temperature side thereof, and the curved line in a portion where the glass transition temperature is changed in a stepwise pattern intersect with each other is made to be the glass transition temperature (Tg), assuming that it is a homopolymer.

In addition, the weight average molecular weight (Mw) of the polymer (A) is, for example, preferably within a range of 30,000 to 5,000,000, more preferably within a range of 100,000 to 2,000,000, and further preferably within a range of 200,000 to 1,000,000. If the weight average molecular weight (Mw) is less than 30,000, the cohesive strength of the pressure-sensitive adhesive becomes insufficient and there are sometimes the cases where an adherend is likely to be stained. On the other hand, if the weight average molecular weight (Mw) is more than 5,000,000, the flowability of the pressure-sensitive adhesive becomes low and there are sometimes the cases where the wetting of an adherend becomes insufficient and thus the adherability is deteriorated.

[(Meth)acryl-Based Polymer (a)]

(Meth)acryl-based polymers (a) as a preferable specific example of the polymer (A) will be described below in detail.

The (meth)acryl-based polymer (a) is a polymer that contains, as a monomer unit (component), a (meth)acrylic acid alkyl ester having, for example, a linear or branched alkyl group of 1 to 20 carbon atoms. In addition, the (meth)acryl-based polymer (a) may have a structure formed only by the (meth)acrylic acid alkyl ester having an alkyl group of 1 to 20 carbon atoms or by a combination of two or more thereof.

Examples of the (meth)acrylic acid alkyl ester having an alkyl group of 1 to 20 carbon atoms include, for example, C₁₋₂₀ alkyl (meth)acrylate [preferably C₂₋₁₄ alkyl (meth)acrylate, further preferably C₂₋₁₀ alkyl (meth)acrylate], such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl(meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl(meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, etc. Note that the “alkyl (meth)acrylate” means an acrylic acid alkyl ester and/or a methacrylic acid alkyl ester, and all of the “(meth) . . . ” expressions have the same meaning as in this case.

The ratio of the alkyl (meth)acrylate having an alkyl group of 1 to 20 carbon atoms is preferably 50 to 99.9% by mass, more preferably 60 to 98% by mass, and further preferably 70 to 96% by mass, based on the total mass of the monomer units (components) for preparing the (meth)acryl-based polymer (a). If such a ratio is within the above range, preferable adhesive properties can be obtained in the pressure-sensitive adhesive sheet that can be used for repeeling applications. Thus, this is a preferable embodiment.

For the purpose of modifying cohesive strength, heat resistance, and crosslinking property, etc., the (meth)acryl-based polymer (a) may contain, if necessary, another monomer unit (component) (copolymerizable monomer) that is copolymerizable with the alkyl (meth)acrylate. Accordingly, the (meth)acryl-based polymer (a) may contain a copolymerizable monomer in addition to the alkyl (meth)acrylate that is a major component. A monomer having a polar group can be preferably used as such a copolymerizable monomer. The major component means a monomer having the highest blending ratio in the total amount of the monomer components.

Further, specific examples of other copolymerizable monomer include:

carboxyl group-containing monomers, such as acrylic acid, methacrylic acid, carboxyethyl acrylate, carboxypentyl acrylate, itaconic acid, maleic acid, fumaric acid, crotonic acid, isocrotonic acid, etc;

acid anhydride group-containing monomers, such as maleic acid anhydride, itaconic acid anhydride, etc.;

sulfonic acid group-containing monomers, such as styrene sulfonic acid, allyl sulfonic acid, 2-(meth)acrylamide-2-methylpropanesulfonic acid, (meth)acrylamide propanesulfonic acid, sulfopropyl (meth)acrylate, (meth)acryloyloxy naphthalenesulfonic acid, etc.;

phosphate group-containing monomers, such as 2-hydroxyethyl acryloyl phosphate, etc.;

(N-substituted)amide-based monomers, such as (meth)acrylamide, N,N-dialkyl (meth)acrylamide (e.g. N,N-dimethyl (meth)acrylamide, N,N-diethyl (meth)acrylamide, N,N-dipropyl (meth)acrylamide, N,N-diisopropyl (meth)acrylamide, N,N-di(n-butyl) (meth)acrylamide, N,N-di(t-butyl) (meth)acrylamide, etc.), N-ethyl (meth)acrylamide, N-isopropyl (meth)acrylamide, N-butyl (meth)acrylamide, N-n-butyl (meth)acrylamide, N-methylol (meth)acrylamide, N-ethylol (meth)acrylamide, N-methylol propane (meth)acrylamide, N-methoxymethyl (meth)acrylamide, N-ethoxymethyl (meth)acrylamide, N-butoxymethyl (meth)acrylamide, N-acryloyl morpholine, etc.;

succinimide-based monomers, such as N-(meth)acryloyloxy methylene succinimide, N-(meth)acryloyl-6-oxyhexamethylene succinimide, N-(meth)acryloyl-8-oxyhexamethylene succinimide, etc.;

maleimide-based monomers, such as N-cyclohexyl maleimide, N-isopropyl maleimide, N-lauryl maleimide, N-phenyl maleimide etc.;

itaconimide-based monomers, such as N-methylitaconimide, N-ethylitaconimide, N-butylitaconimide, N-octylitaconimide, N-2-ethylhexylitaconimide, N-cyclohexylitaconimide, N-laurylitaconimide, etc.;

vinyl esters, such as vinyl acetate, vinyl propionate, etc.;

nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinylmorpholine, N-vinyl-2-piperidone, N-vinyl-3-morpholinone, N-vinyl-2-caprolactam, N-vinyl-1,3-oxazin-2-one, N-vinyl-3,5-morpholinedione, N-vinyl pyrazole, N-vinyl isoxazole, N-vinyl thiazole, N-vinyl isothiazole, N-vinyl-pyridazine, etc.;

N-vinyl carboxylic acid amides;

lactam-based monomers, such as N-vinyl caprolactam, etc.;

cyanoacrylate monomers, such as acrylonitrile, methacrylonitrile, etc.;

aminoalkyl (meth)acrylate-based monomers, such as aminoethyl (meth)acrylate, N,N-dimethylaminoethyl (meth)acrylate, t-butylaminoethyl (meth)acrylate, etc.;

alkoxyalkyl (meth)acrylate-based monomers, such as methoxyethyl (meth)acrylate, ethoxyethyl (meth)acrylate, propoxyethyl (meth)acrylate, butoxyethyl (meth)acrylate, ethoxypropyl (meth)acrylate, etc.;

styrene-based monomers, such as styrene, α-methylstyrene, etc.;

epoxy group-containing acrylic-based monomers, such as glycidyl (meth)acrylate, etc.;

glycol-based acrylic ester monomers, such as polyethylene glycol (meth)acrylate, polypropylene glycol (meth)acrylate, methoxyethylene glycol (meth)acrylate, methoxypolypropylene glycol (meth)acrylate, etc.;

acrylic acid ester-based monomers having a heterocycle, halogen atom, silicon atom, or the like, such as tetrahydrofurfuryl (meth)acrylate, fluorine-containing (meth)acrylate, silicone-containing (meth)acrylate, etc.;

olefin-based monomers, such as isoprene, butadiene, isobutylene, etc.;

vinyl ether-based monomers, such as methyl vinyl ether, ethyl vinyl ether, etc.;

vinyl esters, such as vinyl acetate, vinyl propionate, etc.;

aromatic vinyl compounds, such as vinyl toluene, styrene, etc.;

olefins or dienes, such as ethylene, butadiene, isoprene, isobutylene, etc.;

vinyl ethers, such as vinyl alkyl ether, etc.;

vinyl chloride;

sulfonic acid group-containing monomers, such as sodium vinyl sulfonate, etc.;

imide group-containing monomers, such as cyclohexyl maleimide, isopropyl maleimide etc.;

isocyanate group-containing monomers, such as 2-isocyanatoethyl (meth)acrylate, etc.;

acryloylmorpholine;

(meth)acrylic acid esters having an alicyclic hydrocarbon group, such as cyclopentyl (meth)acrylate, cyclohexyl (meth)acrylate, isobornyl (meth)acrylate, dicyclopentanyl (meth)acrylate, etc.;

(meth)acrylic acid esters having an aromatic hydrocarbon group, such as phenyl (meth)acrylate, phenoxyethyl (meth)acrylate, etc.; and

(meth)acrylic acid esters obtained from terpene compound derivative-derived alcohols. These copolymerizable monomers can be used alone or in combination of two or more thereof.

When the (meth)acryl-based polymer (a) contains a copolymerizable monomer along with the alkyl (meth)acrylate as a major component, the hydroxyl group-containing monomers or the carboxyl group-containing monomers can be preferably used. Among them, 2-hydroxyethyl (meth)acrylate and 4-hydroxybutyl (meth)acrylate as the hydroxyl group-containing monomer, or acrylic acid as the carboxyl group-containing monomer can be preferably used.

The blending amount of the copolymerizable monomer is not particularly limited, but the copolymerizable monomer can be preferably 0.01 to 40% by mass, more preferably 0.1 to 30% by mass, and further preferably 0.5 to 20% by mass, based on the total mass of the monomer units (components) for preparing the (meth)acryl-based polymer (a). By containing the copolymerizable monomer in an amount of 0.01% by mass or more, a decrease in the cohesive strength of a pressure-sensitive adhesive (pressure-sensitive adhesive layer, pressure-sensitive adhesive sheet) formed of the pressure-sensitive adhesive composition can be prevented, and accordingly the staining occurring when the adhesive is peeled off from an adherend can be prevented. Further, by containing the copolymerizable monomer in an amount of 40% by mass or less, it can be prevented that the cohesive strength may become too large, thereby making it possible to improve the tackiness at normal temperature (25° C.)

The (meth)acryl-based polymer (a) may contain an alkylene oxide group-containing reactive monomer having an average addition mole number of 3 to 100 of the oxyalkylene unit as a monomer unit (component).

The average addition mole number of oxyalkylene unit to the alkylene oxide group-containing reactive monomer is preferably from 3 to 100, more preferably from 4 to 80, particularly preferably from 5 to 50, in view of compatibility with the polymer (B). If the average addition mole number is 3 or more, an effect of reducing staining of an adherend (object to be protected) tends to be efficiently obtained. If the average addition mole number is more than 100, the interaction with the polymer (B) is so large that the pressure-sensitive adhesive composition becomes a gel, and unfortunately coating with the composition tends to be difficult to achieve. The end of the oxyalkylene chain in the alkylene oxide group-containing reactive monomer may be maintained as a hydroxyl group or substituted with any other functional group.

The alkylene oxide group-containing reactive monomer may be used alone or as a mixture of two or more thereof, but the total blending amount of such a monomer is preferably 5.0% by mass or less, more preferably 4.0% by mass or less, further preferably 3.0% by mass or less, and especially preferably 1.0% by mass or less, based on the total constituent units (total monomer units (components): 100% by mass) of the (meth)acryl-based polymer (a). The blending amount of the alkylene oxide group-containing reactive monomer exceeding 5.0% by mass is undesirable because it becomes a factor to decrease the adhesive strength.

The oxyalkylene unit of the alkylene oxide group-containing reactive monomer may include one having an alkylene group of 1 to 6 carbon atoms, and examples of such an oxyalkylene group include, for example, an oxymethylene group, an oxyethylene group, an oxypropylene group, an oxybutylene group, and the like. The hydrocarbon group of the oxyalkylene chain may be linear or branched.

In addition, the alkylene oxide group-containing reactive monomer is preferably a reactive monomer having an ethylene oxide group. If a (meth)acryl-based polymer containing a reactive monomer having an ethylene oxide group is used as a base polymer, the compatibility between the base polymer and the polymer (B) is improved and the bleeding onto an adherend is well suppressed, thereby being able to obtain a low staining pressure-sensitive adhesive composition.

Examples of the alkylene oxide group-containing reactive monomer used in the present invention may be a (meth)acrylic acid-alkylene oxide adduct or a reactive surfactant having a reactive substituent such as acryloyl group, methacryloyl group, and allyl group in the molecule.

As the (meth)acrylic acid-alkylene oxide adduct, a compound represented by the following general formula (4) can be preferably used.

[Formula 1]

CH₂═C(R₁)—COO—(CₘH₂ₘO)ₙ—(CₚH₂ₚO)_{q}—R₂ (4)

[In the formula (4), R₁ is hydrogen or a methyl group, R₂ is hydrogen or a monovalent organic group, m and p are each an integer of 2 to 4, and n and q are each 0 or an integer of 2 to 40, provided that n and q are not simultaneously zero.]

Specific examples of the (meth)acrylic acid-alkylene oxide adduct include, for example, polyethylene glycol (meth)acrylate, polypropylene glycol (meth)acrylate, polyethylene glycol-polypropylene glycol (meth)acrylate, polyethylene glycol-polybutylene glycol (meth)acrylate, polypropylene glycol-polybutylene glycol (meth)acrylate, methoxypolyethylene glycol (meth)acrylate, ethoxypolyethylene glycol (meth)acrylate, butoxypolyethylene glycol (meth)acrylate, octoxypolyethylene glycol (meth)acrylate, lauroxypolyethylene glycol (meth)acrylate, stearoxypolyethylene glycol (meth)acrylate, phenoxypolyethylene glycol (meth)acrylate, methoxypolypropylene glycol (meth)acrylate, and octoxypolyethylene glycol-polypropylene glycol (meth)acrylate.

Specific examples of the reactive surfactant include, for example, a reactive anionic surfactant having a (meth)acryloyl group or an allyl group; a reactive nonionic surfactant; a reactive cationic surfactant; and the like.

Examples of the reactive anionic surfactant include, for example, those represented by the formulae (A1) to (A10).

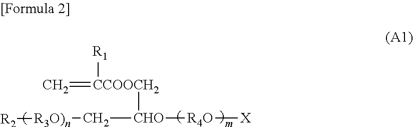

[In the formula (A1), R₁ represents hydrogen or a methyl group; R₂ represents a hydrocarbon group or an acyl group, each having 1 to 30 carbon atoms; X represents an anionic hydrophilic group; R₃ and R₄ are the same or different and each represents an alkylene group of 1 to 6 carbon atoms; and m and n represent an average addition mole number of 0 to 100, provided that (m+n) represents a number of 3 to 100.]

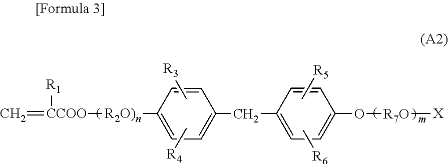

[In the formula (A2), R₁ represents hydrogen or a methyl group; R₂ and R₇ are the same or different and each represents an alkylene group of 1 to 6 carbon atoms; R₃ and R₅ are the same or different and each represents hydrogen or an alkyl group; R₄ and R₆ are the same or different and each represents hydrogen, an alkyl group, a benzyl group, or a styrene group; X represents an anionic hydrophilic group; and m and n represent an average addition mole number of 0 to 100, provided that (m+n) represents a number of 3 to 100.]

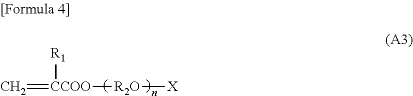

[In the formula (A3), R₁ represents hydrogen or a methyl group; R₂ represents an alkylene group of 1 to 6 carbon atoms; X represents an anionic hydrophilic group; and m and n represent an average addition mole number of 3 to 100.]

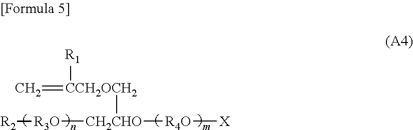

[In the formula (A4), R₁ represents hydrogen or a methyl group; R₂ represents a hydrocarbon group or an acyl group, each having 1 to 30 carbon atoms; R₃ and R₄ are the same or different and each represents an alkylene group of 1 to 6 carbon atoms; X represents an anionic hydrophilic group; and m and n represent an average addition mole number of 0 to 100, provided that (m+n) represents a number of 3 to 100.]

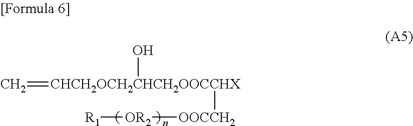

[In the formula (A5), R₁ represents a hydrocarbon group, an amino group, or a carboxylic residue; R₂ represents an alkylene group of 1 to 6 carbon atoms; X represents an anionic hydrophilic group; and n represents an integer of 3 to 100 of an average addition mole number.]

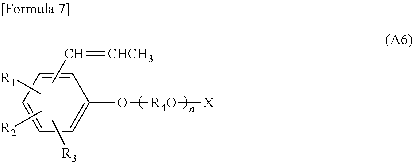

[In the formula (A6), R₁ represents a hydrocarbon group of 1 to 30 carbon atoms; R₂ represents hydrogen or a hydrocarbon group of 1 to 30 carbon atoms; R₃ represents hydrogen or a propenyl group; R₄ represents an alkylene group of 1 to 6 carbon atoms; X represents an anionic hydrophilic group; n represents a number of 3 to 100 of an average addition mole number.]

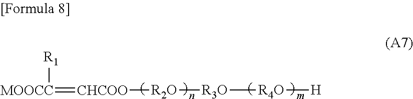

[In the formula (A7), R₁ represents hydrogen or a methyl group; R₂ and R₄ are the same or different and each represents an alkylene group of 1 to 6 carbon atoms; R₃ represents a hydrocarbon group of 1 to 30 carbon atoms; M represents hydrogen, an alkali metal, an ammonium group, or an alkanolammonium group; and m and n represent an average addition mole number of 0 to 40, provided that (m+n) represents a number of 3 to 100.]

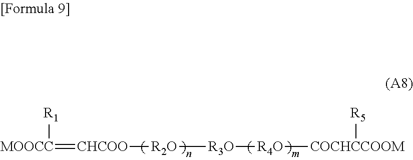

[In the formula (A8), R₁ and R₅ are the same or different and each represents hydrogen or a methyl group; R₂ and R₄ are the same or different and each represents an alkylene group of 1 to 6 carbon atoms; R₃ represents a hydrocarbon group of 1 to 30 carbon atoms; M represents hydrogen, an alkali metal, an ammonium group, or an alkanolammonium group; and m and n represent an average addition mole number of 0 to 100, provided that (m+n) represents a number of 3 to 100.]

[Formula 10]

MOOCCH═CHCOOR₁OR₂ (A9)

[In the formula (A9), R₁ represents an alkylene group of 1 to 6 carbon atoms; R₂ represents a hydrocarbon group of 1 to 30 carbon atoms; M represents hydrogen, an alkali metal, an ammonium group, or an alkanolammonium group; and n represents a number of 3 to 100 of an average addition mole number.]

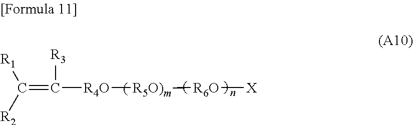

[In the formula (A10), R₁, R₂, and R₃ are the same or different and each represents hydrogen or a methyl group; R₄ represents a hydrocarbon group of 0 to 30 carbon atoms (wherein 0 carbon atoms indicate the absence of R₄); R₅ and R₆ are the same or different and each represents an alkylene group of 1 to 6 carbon atoms; X represents an anionic hydrophilic group; and m and n represent an average addition mole number of 0 to 100, provided that (m+n) represents a number of 3 to 100.]

X in each of the formulae (A1) to (A6), and (A10) represents an anionic hydrophilic group. Examples of the anionic hydrophilic group include groups represented by the following formulae (a1) and (a2).

[Formula 12]

—SO₃M₁ (a1)

[In the formula (a1), M₁ represents hydrogen, an alkali metal, an ammonium group, or an alkanolammonium group.]

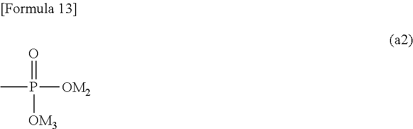

[In the formula (a2), M₂ and M₃ are the same or different and each represents hydrogen, an alkali metal, an ammonium group, or an alkanolammonium group.]

Examples of the nonion type reactive surfactant include those represented by the formulae (N1) to (N6).

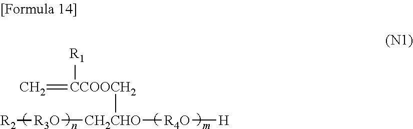

[In the formula (N1), R₁ represents hydrogen or a methyl group;

R₂ represents a hydrocarbon group or an acyl group, each having 1 to 30 carbon atoms; R₃ and R₄ are the same or different and each represents an alkylene group of 1 to 6 carbon atoms; and m and n represent an average addition mole number of 0 to 100, provided that (m+n) represents a number of 3 to 100.]

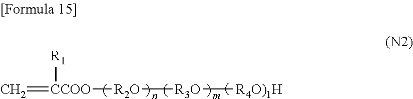

[In the formula (N2), R₁ represents hydrogen or a methyl group; R₂, R₃, and R₄ are the same or different and each represents an alkylene group of 1 to 6 carbon atoms; and n, m and 1 represent an average addition mole number of 0 to 100, provided that (m+n+1) represents a number of 3 to 100.]

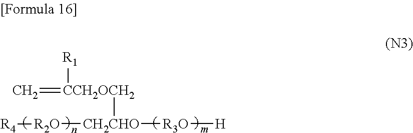

[In the formula (N3), R₁ represents hydrogen or a methyl group; R₂ and R₃ are the same or different and each represents an alkylene group of 1 to 6 carbon atoms; R₄ represents a hydrocarbon group or an acyl group, each having 1 to 30 carbon atoms; and m and n represent an average addition mole number of 0 to 100, provided that (m+n) represents a number of 3 to 100.]

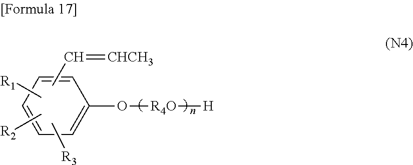

[In the formula (N4), R₁ and R₂ are the same or different and each represents a hydrocarbon group of 1 to 30 carbon atoms; R₃ represents hydrogen or a propenyl group; R₄ represents an alkylene group of 1 to 6 carbon atoms; and n represents a number of 3 to 100 of an average addition mole number.]

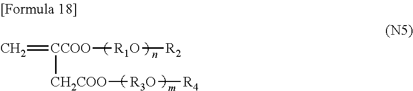

[In the formula (N5), R₁ and R₃ are the same or different and each represents an alkylene group of 1 to 6 carbon atoms; R₂ and R₄ are the same or different and each represents hydrogen, a hydrocarbon group or an acyl group, each having 1 to 30 carbon atoms; and m and n represent an average addition mole number of 0 to 100, provided that (m+n) represents a number of 3 to 100.]

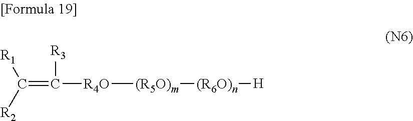

[In the formula (N6), R₁, R₂, and R₃ are the same or different and each represents hydrogen or a methyl group; R₄ represents a hydrocarbon group of 0 to 30 carbon atoms (wherein 0 carbon atoms indicate the absence of R₄); R₅ and R₆ are the same or different and each represents an alkylene group of 1 to 6 carbon atoms; and m and n represent an average addition mole number of 0 to 100, provided that (m+n) represents a number of 3 to 100.]

Examples of commercially available alkylene oxide group-containing reactive monomers include, for example, Blemmer PME-400, Blemmer PME-1000, and Blemmer50POEP-800B (each manufactured by Nippon Oil & Fats Co., Ltd.), Latemul PD-420 and Latemul PD-430 (each manufactured by Kao Corporation), and Adekariasoap ER-10 and Adekariasoap NE-10 (each manufactured by Asahi Denka Kogyo K. K.).

The (meth)acryl-based polymer (a) may contain a poly functional monomer as needed, in order to adjust the cohesive strength of the pressure-sensitive adhesive (layer) to be formed.

Examples of the polyfunctional monomer include, for example, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate, butyl di(meth)acrylate, and hexyl di(meth)acrylate, etc. Among them, trimethylolpropane tri(meth)acrylate, hexanediol di(meth)acrylate, and dipentaerythritol hexa(meth)acrylate can be preferably used. The polyfunctional (meth)acrylates can be used alone or in combination of two or more thereof.

The blending amount of the polyfunctional monomer varies depending on the molecular weight or the number of functional groups thereof, but the polyfunctional monomer is added in an amount within a range of 0.01 to 3.0% by mass, preferably within a range of 0.02 to 2.0% by mass, and further preferably within a range of 0.03 to 1.0% by mass, based on the total mass of the monomer units (components) for preparing the (meth)acryl-based polymer (a). If the blending amount of the polyfunctional monomer exceeds 3.0% by mass based on the total mass of the monomer units (components) for preparing the (meth)acryl-based polymer (a), for example, there are sometimes the cases where the cohesive strength of the pressure-sensitive adhesive (layer) becomes too high and the adhesive strength (high-speed peeling strength, low-speed peeling strength) is reduced. On the other hand, if the blending amount of the polyfunctional monomer is less than 0.01% by mass, for example, there are sometimes the cases where the cohesive strength of the pressure-sensitive adhesive (layer) is reduced and staining occurs at the time of peeling off from the adherend (object to be protected).

In order to adjust the molecular weight of the (meth)acryl-based polymer (a), a chain transfer agent can be used while the polymer (a) is being polymerized. Examples of the chain transfer agent to be used include: compounds having a mercapto group, such as octyl mercaptan, lauryl mercaptan, t-dodecyl mercaptan, mercaptoethanol, and α-thioglycerol; thioglycolic acid, thioglycolic acid esters such as methyl thioglycolate, ethyl thioglycolate, propyl thioglycolate, butyl thioglycolate, t-butyl thioglycolate, 2-ethylhexyl thioglycolate, octyl thioglycolate, decyl thioglycolate, dodecyl thioglycolate, thioglycolic acid ester of ethylene glycol, thioglycolic acid ester of neopentyl glycol, and thioglycolic acid ester of pentaerythritol; α-methylstyrenedimer; and the like.

In preparing the (meth)acryl-based polymer (a), the (meth)acryl-based polymer can be easily formed by a curing reaction using heat or ultraviolet rays with the use of a polymerization initiator, such as thermal polymerization initiator, photopolymerization initiator (photo-initiator), or, the like. In particular, thermal polymerization can be preferably used in terms of the advantage that a polymerization time can be shortened. The polymerization initiators can be used alone or in combination of two or more thereof.

Examples of the thermal polymerization initiator include, for example, azo-based polymerization initiators (for example, 2,2′-azobisisobutyronitrile, 2,2′-azobis-2-methylbutyronitrile, 2,2′-azobis(2-methylpropionic acid)dimethyl, 4,4′-azobis-4-cyanovalerianic acid, azobisisovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, and 2,2′-azobis(N,N′-dimethyleneisobutylamidine)dihydrochloride, etc.); peroxide-based polymerization initiators (for example, dibenzoyl peroxide, t-butyl permaleate, and lauroyl peroxide, etc.); redox-based polymerization initiators; and the like.

The blending amount of the thermal polymerization initiator is not particularly limited, but is blended, for example, in an amount within a range of preferably 0.01 to 5 parts by mass, more preferably 0.05 to 3 parts by mass, based on 100 parts by mass of the total monomer units (components) for preparing the (meth)acryl-based monomer (a).

The photopolymerization initiator is not particularly limited, but, for example, there can be used a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, a thioxanthone-based photopolymerization initiator, an acylphosphine oxide-based photopolymerization initiator, or the like.

Specific examples of the benzoin ether-based photopolymerization initiator include, for example, benzoin methyl ether, benzoin ethyl ether, benzoin propyl ether, benzoin isopropyl ether, benzoin isobutyl ether, 2,2-dimethoxy-1,2-diphenylethane-1-one [trade name: IRGACURE 651, manufactured by BASF Japan Ltd.], and anisole methyl ether, etc. Specific examples of the acetophenone-based photopolymerization initiator include, for example, 1-hydroxycyclohexyl phenyl ketone [trade name: IRGACURE 184, manufactured by BASF Japan Ltd.], 4-phenoxydichloro-acetophenone, 4-t-butyl-dichloroacetophenone, 1-[4-(2-hydroxyethoxy)-phenyl]-2-hydroxy-2-methyl-1-propane-1-one [trade name: IRGACURE 2959, manufactured by BASF Japan Ltd.], 2-hydroxy-2-methyl-1-phenyl-propane-1-one [trade name: DAROCUR 1173, manufactured by BASF Japan Ltd.], and methoxyacetophenone, etc. Specific examples of the α-ketol photopolymerization initiator include, for example, 2-methyl-2-hydroxypropiophenone and 1-[4-(2-hydroxyethyl)-phenyl]-2-hydroxy-2-methylpropane-1-one, etc. Specific examples of the aromatic sulfonyl chloride photopolymerization initiator include, for example, 2-naphthalene sulfonyl chloride, etc. Specific examples of the photoactive oxime-based photopolymerization initiator include, for example, 1-phenyl-1,1-propanedione-2-(o-ethoxycarbonyl)-oxime, etc.

Specific examples of the benzoin-based photopolymerization initiator include, for example, benzoin, etc. Specific examples of the benzyl-based photopolymerization initiator include, for example, benzyl, etc. Specific examples of the benzophenone-based photopolymerization initiators include, for example, benzophenone, benzoylbenzoic acid, 3,3′-dimethyl-4-methoxybenzophenone, polyvinyl benzophenone, and α-hydroxycyclohexyl phenyl ketone, etc. Specific examples of the ketal-based photopolymerization initiator include, for example, benzyl dimethyl ketal, etc. Specific examples of the thioxanthone-based photopolymerization initiator include, for example, thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, and dodecylthioxanthone, etc.

Examples of the acylphosphine-based photopolymerization initiator include, for example, bis(2,6-dimethoxybenzoyl)phenylphosphine oxide, bis(2,6-dimethoxybenzoyl) (2,4,4-trimethylpentyl)phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl)phosphine oxide, bis(2,6-dibutoxybenzoyl)(2-methylpropane-1-yl)phosphine oxide, bis(2,4-dimethoxybenzoyl)(2-methypropane-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

The blending amount of the photopolymerization initiator is not particularly limited, but the photopolymerization initiator is blended, for example, in an amount preferably within a range of 0.01 to 5 parts by mass, more preferably within a range of 0.05 to 3 parts by mass, based on the total mass (100 parts by mass) of the monomer components for preparing the (meth)acryl-based polymer (a). If the blending amount of the photopolymerization initiator is less than 0.01 parts by mass, there are sometimes the cases where a polymerization reaction becomes insufficient. If the blending amount thereof is more than 5 parts by mass, there are sometimes the cases where an ultraviolet ray does not reach the inside of the pressure-sensitive adhesive layer, because the photopolymerization initiator absorbs the ultraviolet rays. In this case, a decrease in the rate of polymerization is caused, or the molecular weight of the generated polymer becomes smaller. Thereby, the cohesive strength of the resulting pressure-sensitive adhesive (layer) becomes smaller, and hence there are sometimes the cases where, when the pressure-sensitive adhesive layer is peeled off from a film, a part of the pressure-sensitive adhesive layer remains on the film and accordingly the film cannot be reused.

In the present invention, the (meth)acryl-based polymer (a) can also be prepared as a partial polymer ((meth)acryl-based polymer syrup) that can be obtained by radiating ultraviolet (UV) rays onto a mixture in which the aforementioned monomer components and the polymerization initiator have been blended, so that the monomer components are partially polymerized. A pressure-sensitive adhesive composition is prepared by blending the later-described polymer (B) into the (meth)acryl-based polymer syrup, and then polymerization can also be completed by coating the pressure-sensitive adhesive composition on a predetermined object (substrate film, etc.) to be coated and by irradiating the coated product with UV rays.

There are no particular limitations on the method used to obtain the polymer (A) (particularly the (meth)acryl-based polymer (a)), and various polymerization methods can be carried out that have been generally employed as a synthetic method for the polymer (A) (particularly the (meth)acryl-based polymer (a)), such as solution polymerization, emulsion polymerization, bulk polymerization, suspension polymerization, and radiation-curable polymerization, etc. When the pressure-sensitive adhesive sheet of the present invention is used as a surface protecting sheet described later, the solution polymerization and emulsion polymerization are preferably employed from the viewpoint of productivity of the pressure-sensitive adhesive sheet. The polymer obtained may be any of random copolymers, block copolymers, alternating copolymers, graft copolymers, and the like.

### [Polymer (B)]

The polymer (B) is a polymer characterized by containing a reactive ionic liquid as a monomer unit and having an intrinsic viscosity (dL/g) of 0.01 or more and less than 0.5, and functions as an antistatic component in the pressure-sensitive adhesive composition of the present invention. The polymer (B) is not particularly limited as long as it is a polymer containing a reactive ionic liquid as a monomer unit, but a (meth)acryl-based polymer with high transparency is preferred.

The intrinsic viscosity (dL/g) of the polymer (B) is 0.01 or more and less than 0.5, preferably 0.015 or more and less than 0.49, further preferably 0.02 or more and less than 0.48. If the intrinsic viscosity of the polymer (B) is within the above range, a moderate compatibility with the polymer (A) is developed and a pressure-sensitive adhesive composition (pressure-sensitive adhesive layer, pressure-sensitive adhesive sheet) with high transparency is obtained, and therefore a preferable embodiment can be achieved. In addition, a pressure-sensitive adhesive (pressure-sensitive adhesive layer, pressure-sensitive adhesive sheet) formed by using a pressure-sensitive adhesive composition containing the polymer (B) having an intrinsic viscosity within a specific range shows a small adhesive strength at the time of high-speed peeling, but it is possible to sufficiently increase an adhesive strength to the extent that does not cause problems such as lifting or peeling off at the time of low-speed peeling. It is estimated that this is because the polymer (B) containing a reactive ionic liquid as a monomer unit and having an intrinsic viscosity within a certain range is localized on the pressure-sensitive adhesive layer surface while being moderately compatible to the polymer (A), thereby to develop an antistatic property and suppress an increase in the adhesive strength at the time of high-speed peeling. Note that the intrinsic viscosity is a value measured according to the method described in JIS-K7367-1.

The polymer (B) of the present invention contains a reactive ionic liquid as a monomer unit (component) that is an essential component. The “reactive ionic liquid” in the present invention refers to an ionic liquid having a polymerizable functional group (reactive double bond) in a cation moiety and/or an anion moiety (either or both) constituting the ionic liquid, which is a liquid (liquid form) at any temperature within a range of 0 to 150° C., a non-volatile melt salt, and transparent. The polymerizable functional group includes, for example, a vinyl group, an allyl group, a (meth)acryloyl group, and the like. Among them, the (meth)acryloyl and vinyl groups are preferred and the (meth)acryloyl group is especially preferred.

The cation moiety of the reactive ionic liquid is not particularly limited, but examples thereof include a quaternary ammonium cation, an imidazolium cation, a pyridinium cation, a piperidinium cation, a pyrrolidinium cation, a quaternary phosphonium cation, a trialkylsulphonium cation, a pyrrole cation, a pyrazolium cation, a guanidium cation, and the like, and among which it is more preferable to use a quaternary ammonium cation, an imidazolium cation, a pyridinium cation, a piperidinium cation, a pyrrolidinium cation, a quaternary phosphonium cation, or a trialkylsulphonium cation.

In addition, in the anion moiety constituting the reactive ionic liquid, the anion includes SCN⁻, BF₄⁻, PF₆⁻, NO₃⁻, CH₃COO⁻, CF₃COO⁻, CH₃SO₃⁻, CF₃SO₃⁻, (FSO₂)₂N⁻, (CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂) (CF₃CO)N⁻, B(CN)₄⁻, C(CN)₃⁻, N(CN)₂⁻, CH₃OSO₃⁻, C₂H₅OSO₃⁻, C₄H₉OSO₃⁻, C₆H₁₃OSO₃⁻, C₈H₁₇OSO₃⁻, p-toluenesulfonate anion, 2-(2-methoxyethyl)ethyl sulfate anion, (C₂F₅)₃PF₃⁻, and the like, and in particular, an anion component containing a fluorine atom (fluorine-containing anion) is preferable because an ionic liquid with a low melting point is obtained and is excellent in antistatic properties. Further, it is preferable not to use a chlorine ion, a bromine ion or the like as the anion, because they have corrosion properties.

The reactive ionic liquid can be appropriately selected from combinations of the cation moiety and anion moiety described above to be used, and includes specifically various ionic liquids shown below.

The imidazolium cation-based ionic liquid includes:

an ionic liquid containing a 1-alkyl-3-vinylimidazolium cation, such as 1-alkyl-3-vinylimidazolium tetrafluoroborate, 1-alkyl-3-vinylimidazolium trifluoroacetate, 1-alkyl-3-vinylimidazolium heptafluorobutyrate, 1-alkyl-3-vinylimidazolium trifluoromethanesulfonate, 1-alkyl-3-vinylimidazolium perfluorobutanesulfonate, 1-alkyl-3-vinylimidazolium bis(trifluoromethanesulfonyl)imide, 1-alkyl-3-vinylimidazolium bis(pentafluoroethanesulfonyl)imide, 1-alkyl-3-vinylimidazolium tris(trifluoromethanesulfonyl)imide, 1-alkyl-3-vinylimidazolium hexafluorophosphate, 1-alkyl-3-vinylimidazolium(trifluoromethanesulfonyl)trifluoroacetamide, 1-alkyl-3-vinylimidazolium dicyanamide, 1-alkyl-3-vinylimidazolium thiocyanate, and the like;

an ionic liquid containing a 1,2-dialkyl-3-vinylimidazolium cation, such as 1,2-dialkyl-3-vinylimidazolium bis(fluorosulfonyl)imide, 1,2-dialkyl-3-vinylimidazolium bis(trifluoromethanesulfonyl)imide, 1,2-dialkyl-3-vinylimidazolium dicyanamide, 1,2-dialkyl-3-vinylimidazolium thiocyanate, and the like;

an ionic liquid containing a 2-alkyl-1,3-divinylimidazolium cation, such as 2-alkyl-1,3-divinylimidazolium bis(fluorosulfonyl)imide, 2-alkyl-1,3-divinylimidazolium bis(trifluoromethanesulfonyl)imide, 2-alkyl-1,3-divinylimidazolium dicyanamide, 2-alkyl-1,3-divinylimidazolium thiocyanate, and the like;

an ionic liquid containing a 1-vinylimidazolium cation, such as 1-vinylimidazolium bis(fluorosulfonyl)imide, 1-vinylimidazolium bis(trifluoromethanesulfonyl)imide, 1-vinylimidazolium dicyanamide, 1-vinylimidazolium thiocyanate, and the like;

an ionic liquid containing a 1-alkyl-3-(meth)acryloyloxyalkylimidazolium cation, such as 1-alkyl-3-(meth)acryloyloxyalkylimidazolium tetrafluoroborate, 1-alkyl-3-(meth)acryloyloxyalkylimidazolium trifluoroacetate, 1-alkyl-3-(meth)acryloyloxyalkylimidazolium heptafluorobutyrate, 1-alkyl-3-(meth)acryloyloxyalkylimidazolium trifluoromethanesulfonate, 1-alkyl-3-(meth)acryloyloxyalkylimidazolium perfluorobutanesulfonate, 1-alkyl-3-(meth)acryloyloxyalkylimidazolium bis(trifluoromethanesulfonyl)imide, 1-alkyl-3-(meth)acryloyloxyalkylimidazolium bis(pentafluoroethanesulfonyl)imide, 1-alkyl-3-(meth)acryloyloxyalkylimidazolium tris(trifluoromethanesulfonyl)imide, 1-alkyl-3-(meth)acryloyloxyalkylimidazolium hexafluorophosphate, 1-alkyl-3-(meth)acryloyloxyalkylimidazolium (trifluoromethanesulfonyl)trifluoroacetamide, 1-alkyl-3-(meth)acryloyloxyalkylimidazolium dicyanamide, 1-alkyl-3-(meth)acryloyloxyalkylimidazolium thiocyanate, and the like;

an ionic liquid containing a 1-alkyl-3-(meth)acryloylaminoalkylimidazolium cation, such as 1-alkyl-3-(meth)acryloylaminoalkylimidazolium tetrafluoroborate, 1-alkyl-3-(meth)acryloylaminoalkylimidazolium trifluoroacetate, 1-alkyl-3-(meth)acryloylaminoalkylimidazolium heptafluorobutyrate, 1-alkyl-3-(meth)acryloylaminoalkylimidazolium trifluoromethanesulfonate, 1-alkyl-3-(meth)acryloylaminoalkylimidazolium perfluorobutanesulfonate, 1-alkyl-3-(meth)acryloylaminoalkylimidazolium bis(trifluoromethanesulfonyl)imide, 1-alkyl-3-(meth)acryloylaminoalkylimidazolium bis(pentafluoroethanesulfonyl)imide, 1-alkyl-3-(meth)acryloylaminoalkylimidazolium tris(trifluoromethanesulfonyl)imide, 1-alkyl-3-(meth)acryloylaminoalkylimidazolium hexafluorophosphate, 1-alkyl-3-(meth)acryloylaminoalkylimidazolium (trifluoromethanesulfonyl)trifluoroacetamide, 1-alkyl-3-(meth)acryloylaminoalkylimidazolium dicyanamide, 1-alkyl-3-(meth)acryloylaminoalkylimidazolium thiocyanate, and the like;

an ionic liquid containing a 1,2-dialkyl-3-(meth)acryloyloxyalkylimidazolium cation, such as 1,2-dialkyl-3-(meth)acryloyloxyalkylimidazolium bis(fluorosulfonyl)imide, 1,2-dialkyl-3-(meth)acryloyloxyalkylimidazolium bis(trifluoromethanesulfonyl)imide, 1,2-dialkyl-3-(meth)acryloyloxyalkylimidazolium dicyanamide, 1,2-dialkyl-3-(meth)acryloyloxyalkylimidazolium thiocyanate, and the like;

an ionic liquid containing a 1,2-dialkyl-3-(meth)acryloylaminoalkylimidazolium cation, such as 1,2-dialkyl-3-(meth)acryloylaminoalkylimidazolium bis(fluorosulfonyl)imide, 1,2-dialkyl-3-(meth)acryloylaminoalkylimidazolium bis(trifluoromethanesulfonyl)imide, 1,2-dialkyl-3-(meth)acryloylaminoalkylimidazolium dicyanamide, 1,2-dialkyl-3-(meth)acryloylaminoalkylimidazolium thiocyanate, and the like;

an ionic liquid containing a 2-alkyl-1,3-di(meth)acryloyloxyalkylimidazolium cation, such as 2-alkyl-1,3-di(meth)acryloyloxyalkylimidazolium bis(fluorosulfonyl)imide, 2-alkyl-1,3-di(meth)acryloyloxyalkylimidazolium bis(trifluoromethanesulfonyl)imide, 2-alkyl-1,3-di(meth)acryloyloxyalkylimidazolium dicyanamide, 2-alkyl-1,3-di(meth)acryloyloxyalkylimidazolium thiocyanate, and the like;

an ionic liquid containing a 2-alkyl-1,3-di(meth)acryloylaminoalkylimidazolium cation, such as 2-alkyl-1,3-di(meth)acryloylaminoalkylimidazolium bis(fluorosulfonyl)imide, 2-alkyl-1,3-di(meth)acryloylaminoalkylimidazolium bis(trifluoromethanesulfonyl)imide, 2-alkyl-1,3-di(meth)acryloylaminoalkylimidazolium dicyanamide, 2-alkyl-1,3-di(meth)acryloylaminoimidazolium thiocyanate, and the like;

an ionic liquid containing a 1-(meth)acryloyloxyalkylimidazolium cation, such as 1-(meth)acryloyloxyalkylimidazolium bis(fluorosulfonyl)imide, 1-(meth)acryloyloxyalkylimidazolium bis(trifluoromethanesulfonyl)imide, 1-(meth)acryloyloxyalkylimidazolium dicyanamide, 1-(meth)acryloyloxyalkylimidazoliumthiocyanate, and the like; and

an ionic liquid containing a 1-(meth)acryloylaminoalkylimidazolium cation, such as 1-(meth)acryloylaminoalkylimidazolium bis(fluorosulfonyl)imide, 1-(meth)acryloylaminoalkylimidazolium bis(trifluoromethanesulfonyl)imide, 1-(meth)acryloylaminoalkylimidazolium dicyanamide, 1-(meth)acryloylaminoalkylimidazolium thiocyanate, and the like.

Further, the alkyl substituent described above is an alkyl group of preferably 1 to 16 carbon atoms, especially preferably 1 to 12 carbon atoms, and further preferably 1 to 6 carbon atoms.

The pyridinium cation-based ionic liquid includes:

an ionic liquid containing a 1-vinylpyridinium cation, such as 1-vinylpyridinium bis(fluorosulfonyl)imide, 1-vinylpyridinium bis(trifluoromethanesulfonyl)imide, 1-vinylpyridiniumdicyanamide, 1-vinylpyridiniumthiocyanate, and the like;

an ionic liquid containing a 1-(meth)acryloyloxyalkylpyridinium cation, such as 1-(meth)acryloyloxyalkylpyridinium bis(fluorosulfonyl)imide, 1-(meth)acryloyloxyalkylpyridinium bis(trifluoromethanesulfonyl)imide, 1-(meth)acryloyloxyalkylpyridinium dicyanamide, 1-(meth)acryloyloxyalkylpyridinium thiocyanate, and the like;

an ionic liquid containing a 1-(meth)acryloylaminoalkylpyridinium cation, such as 1-(meth)acryloylaminoalkylpyridinium bis(fluorosulfonyl)imide, 1-(meth)acryloylaminoalkylpyridinium bis(trifluoromethanesulfonyl)imide, 1-(meth)acryloylaminoalkylpyridinium dicyanamide, 1-(meth)acryloylaminoalkylpyridinium thiocyanate, and the like;

an ionic liquid containing a 2-alkyl-1-vinylpyridinium cation, such as 2-alkyl-1-vinylpyridinium bis(fluorosulfonyl)imide, 2-alkyl-1-vinylpyridinium bis(trifluoromethanesulfonyl)imide, 2-alkyl-1-vinylpyridinium dicyanamide, 2-alkyl-1-vinylpyridinium thiocyanate, and the like;

an ionic liquid containing a 2-alkyl-1-(meth)acryloyloxyalkylpyridinium cation, such as 2-alkyl-1-(meth)acryloyloxyalkylpyridinium bis(fluorosulfonyl)imide, 2-alkyl-1-(meth)acryloyloxyalkylpyridinium bis(trifluoromethanesulfonyl)imide, 2-alkyl-1-(meth)acryloyloxyalkylpyridinium dicyanamide, 2-alkyl-1-(meth)acryloyloxyalkylpyridinium thiocyanate, and the like;

an ionic liquid containing a 2-alkyl-1-(meth)acryloylaminoalkylpyridinium cation, such as 2-alkyl-1-(meth)acryloylaminoalkylpyridinium bis(fluorosulfonyl)imide, 2-alkyl-1-(meth)acryloylaminoalkylpyridinium bis(trifluoromethanesulfonyl)imide, 2-alkyl-1-(meth)acryloylaminoalkylpyridinium dicyanamide, 2-alkyl-1-(meth)acryloylaminoalkylpyridinium thiocyanate, and the like;

an ionic liquid containing a 3-alkyl-1-vinylpyridinium cation, such as 3-alkyl-1-vinylpyridinium bis(fluorosulfonyl)imide, 3-alkyl-1-vinylpyridinium bis(trifluoromethanesulfonyl)imide, 3-alkyl-1-vinylpyridinium dicyanamide, 3-alkyl-1-vinylpyridinium thiocyanate, and the like;

an ionic liquid containing a 3-alkyl-1-(meth)acryloyloxyalkylpyridinium cation, such as 3-alkyl-1-(meth)acryloyloxyalkylpyridinium bis(fluorosulfonyl)imide, 3-alkyl-1-(meth)acryloyloxyalkylpyridinium bis(trifluoromethanesulfonyl)imide, 3-alkyl-1-(meth)acryloyloxyalkylpyridinium dicyanamide, 3-alkyl-1-(meth)acryloyloxyalkylpyridinium thiocyanate, and the like;

an ionic liquid containing a 3-alkyl-1-(meth)acryloylaminoalkylpyridinium cation, such as 3-alkyl-1-(meth)acryloylaminoalkylpyridinium bis(fluorosulfonyl)imide, 3-alkyl-1-(meth)acryloylaminoalkylpyridinium bis(trifluoromethanesulfonyl)imide, 3-alkyl-1-(meth)acryloylaminoalkylpyridinium dicyanamide, 3-alkyl-1-(meth)acryloylaminoalkylpyridinium thiocyanate, and the like;

an ionic liquid containing a 4-alkyl-1-vinylpyridinium cation, such as 4-alkyl-1-vinylpyridinium bis(fluorosulfonyl)imide, 4-alkyl-1-vinylpyridinium bis(trifluoromethanesulfonyl)imide, 4-alkyl-1-vinylpyridinium dicyanamide, 4-alkyl-1-vinylpyridinium thiocyanate, and the like;

an ionic liquid containing a 4-alkyl-1-(meth)acryloyloxyalkylpyridinium cation, such as 4-alkyl-1-(meth)acryloyloxyalkylpyridinium bis(fluorosulfonyl)imide, 4-alkyl-1-(meth)acryloyloxyalkylpyridinium bis(trifluoromethanesulfonyl)imide, 4-alkyl-1-(meth)acryloyloxyalkylpyridinium dicyanamide, 4-alkyl-1-(meth)acryloyloxyalkylpyridinium thiocyanate, and the like; and

an ionic liquid containing a 4-alkyl-1-(meth)acryloylaminoalkylpyridinium cation, such as 4-alkyl-1-(meth)acryloylaminoalkylpyridinium bis(fluorosulfonyl)imide, 4-alkyl-1-(meth)acryloylaminoalkylpyridinium bis(trifluoromethanesulfonyl)imide, 4-alkyl-1-(meth)acryloylaminoalkylpyridinium dicyanamide, 4-alkyl-1-(meth)acryloylaminoalkylpyridinium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

The piperidinium cation-based ionic liquid includes:

an ionic liquid containing a 1-alkyl-1-vinylalkylpiperidinium cation, such as 1-alkyl-1-vinylalkylpiperidinium bis(fluorosulfonyl)imide, 1-alkyl-1-vinylalkylpiperidinium bis(trifluoromethanesulfonyl)imide, 1-alkyl-1-vinylalkylpiperidinium dicyanamide, 1-alkyl-1-vinylalkylpiperidinium thiocyanate, and the like;

an ionic liquid containing a 1-alkyl-1-(meth)acryloyloxyalkylpiperidinium cation, such as 1-alkyl-1-(meth)acryloyloxyalkylpiperidinium bis(fluorosulfonyl)imide, 1-alkyl-1-(meth)acryloyloxyalkylpiperidinium bis(trifluoromethanesulfonyl)imide, 1-alkyl-1-(meth)acryloyloxyalkylpiperidinium dicyanamide, 1-alkyl-1-(meth)acryloyloxyalkylpiperidinium thiocyanate, and the like; and

an ionic liquid containing a 1-alkyl-1-(meth)acryloylaminoalkylpiperidinium cation, such as 1-alkyl-1-(meth)acryloylaminoalkylpiperidinium bis(fluorosulfonyl)imide, 1-alkyl-1-(meth)acryloylaminoalkylpiperidinium bis(trifluoromethanesulfonyl)imide, 1-alkyl-1-(meth)acryloylaminoalkylpiperidinium dicyanamide, 1-alkyl-1-(meth)acryloylaminoalkylpiperidinium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

The pyrrolidinium cation-based ionic liquid includes:

an ionic liquid containing a 1-alkyl-1-vinylalkylpyrrolidinium cation, such as 1-alkyl-1-vinylalkylpyrrolidinium bis(fluorosulfonyl)imide, 1-alkyl-1-vinylalkylpyrrolidinium bis(trifluoromethanesulfonyl)imide, 1-alkyl-1-vinylalkylpyrrolidinium dicyanamide, 1-alkyl-1-vinylalkylpyrrolidinium thiocyanate, and the like;

an ionic liquid containing a 1-alkyl-1-(meth)acryloyloxyalkylpyrrolidinium cation, such as 1-alkyl-1-(meth)acryloyloxyalkylpyrrolidinium bis(fluorosulfonyl)imide, 1-alkyl-1-(meth)acryloyloxyalkylpyrrolidinium bis(trifluoromethanesulfonyl)imide, 1-alkyl-1-(meth)acryloyloxyalkylpyrrolidinium dicyanamide, 1-alkyl-1-(meth)acryloyloxyalkylpyrrolidinium thiocyanate, and the like; and

an ionic liquid containing a 1-alkyl-1-(meth)acryloylaminoalkylpyrrolidinium cation, such as 1-alkyl-1-(meth)acryloylaminoalkylpyrrolidinium bis(fluorosulfonyl)imide, 1-alkyl-1-(meth)acryloylaminoalkylpyrrolidinium bis(trifluoromethanesulfonyl)imide, 1-alkyl-1-(meth)acryloylaminoalkylpyrrolidinium dicyanamide, 1-alkyl-1-(meth)acryloylaminoalkylpyrrolidinium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

The trialkylsulfonium cation-based ionic liquid includes:

an ionic liquid containing a dialkyl(vinyl)sulfonium cation, such as dialkyl(vinyl)sulfonium bis(fluorosulfonyl)imide, dialkyl(vinyl)sulfonium bis(trifluoromethanesulfonyl)imide, dialkyl(vinyl)sulfonium dicyanamide, dialkyl(vinyl)sulfonium thiocyanate, and the like;

an ionic liquid containing a dialkyl((meth)acryloyloxyalkyl)sulfonium cation, such as dialkyl((meth)acryloyloxyalkyl)sulfonium bis(fluorosulfonyl)imide, dialkyl((meth)acryloyloxyalkyl)sulfonium bis(trifluoromethanesulfonyl)imide, dialkyl((meth)acryloyloxyalkyl)sulfonium dicyanamide, dialkyl((meth)acryloyloxyalkyl)sulfoniumthiocyanate, and the like; and

an ionic liquid containing a dialkyl((meth)acryloylaminoalkyl)sulfonium cation, such as dialkyl((meth)acryloylaminoalkyl)sulfonium bis(fluorosulfonyl)imide, dialkyl((meth)acryloylaminoalkyl)sulfonium bis(trifluoromethanesulfonyl)imide, dialkyl((meth)acryloylaminoalkyl)sulfonium dicyanamide, dialkyl((meth)acryloylaminoalkyl)sulfonium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

The quaternary phosphonium cation-based ionic liquid includes:

an ionic liquid containing a trialkyl(vinyl)phosphonium cation, such as trialkyl(vinyl)phosphonium bis(fluorosulfonyl)imide, trialkyl(vinyl)phosphonium bis(trifluoromethanesulfonyl)imide, trialkyl(vinyl)phosphonium dicyanamide, trialkyl(vinyl)phosphonium thiocyanate, and the like;

an ionic liquid containing a trialkyl((meth)acryloyloxyalkyl)phosphonium cation, such as trialkyl((meth)acryloyloxyalkyl)phosphonium bis(fluorosulfonyl)imide, trialkyl((meth)acryloyloxyalkyl)phosphonium bis(trifluoromethanesulfonyl)imide, trialkyl((meth)acryloyloxyalkyl)phosphonium dicyanamide, trialkyl((meth)acryloyloxyalkyl) phosphonium thiocyanate, and the like; and

an ionic liquid containing a trialkyl ((meth)acryloylaminoalkyl) phosphonium cation, such as trialkyl((meth)acryloylaminoalkyl)phosphonium bis(fluorosulfonyl)imide, trialkyl((meth)acryloylaminoalkyl)phosphonium bis(trifluoromethanesulfonyl)imide, trialkyl((meth)acryloylaminoalkyl)phosphonium dicyanamide, trialkyl((meth)acryloylaminoalkyl)phosphonium thiocyanate, and the like;

Further, the alkyl substituent described above is an alkyl group having preferably 1 to 16 carbon atoms, especially preferably 1 to 12 carbon atoms, and further preferably 1 to 6 carbon atoms.

In addition, the quaternary ammonium cation-based ionic liquid includes:

an ionic liquid containing an N,N,N-trialkyl-N-vinylammonium cation, such as N,N,N-trialkyl-N-vinylammonium tetrafluoroborate, N,N,N-trialkyl-N-vinylammonium trifluoroacetate, N,N,N-trialkyl-N-vinylammonium heptafluorobutyrate, N,N,N-trialkyl-N-vinylammonium trifluoromethanesulfonate, N,N,N-trialkyl-N-vinylammonium perfluorobutanesulfonate, N,N,N-trialkyl-N-vinylammonium bis(trifluoromethanesulfonyl)imide, N,N,N-trialkyl-N-vinylammonium bis(pentafluoroethanesulfonyl)imide, N,N,N-trialkyl-N-vinylammonium tris(trifluoromethanesulfonyl)imide, N,N,N-trialkyl-N-vinylammonium hexafluorophosphate, N,N,N-trialkyl-N-vinylammonium (trifluoromethanesulfonyl)trifluoroacetamide, N,N,N-trialkyl-N-vinylammonium dicyanamide, N,N,N-trialkyl-N-vinylammonium thiocyanate, and the like;

an ionic liquid containing an N,N,N-trialkyl-N-(meth)acryloyloxyalkylammonium cation, such as N,N,N-trialkyl-N-(meth)acryloyloxyalkylammonium tetrafluoroborate, N,N,N-trialkyl-N-(meth)acryloyloxyalkylammonium trifluoroacetate, N,N,N-trialkyl-N-(meth)acryloyloxyalkylammonium heptafluorobutyrate, N,N,N-trialkyl-N-(meth)acryloyloxyalkylammonium trifluoromethanesulfonate, N,N,N-trialkyl-N-(meth)acryloyloxyalkylammonium perfluorobutanesulfonate, N,N,N-trialkyl-N-(meth)acryloyloxyalkylammonium bis(trifluoromethanesulfonyl)imide, N,N,N-trialkyl-N-(meth)acryloyloxyalkylammonium bis(pentafluoroethanesulfonyl)imide, N,N,N-trialkyl-N-(meth)acryloyloxyalkylammonium tris(trifluoromethanesulfonyl)imide, N,N,N-trialkyl-N-(meth)acryloyloxyalkylammonium hexafluorophosphate, N,N,N-trialkyl-N-(meth)acryloyloxyalkylammonium (trifluoromethanesulfonyl)trifluoroacetamide, N,N,N-trialkyl-N-(meth)acryloyloxyalkylammonium dicyanamide, N,N,N-trialkyl-N-(meth)acryloyloxyalkylammonium thiocyanate, and the like; and

an ionic liquid containing an N,N,N-trialkyl-N-(meth)acryloylaminoalkylammonium cation, such as N,N,N-trialkyl-N-(meth)acryloylaminoalkylammonium tetrafluoroborate, N,N,N-trialkyl-N-(meth)acryloylaminoalkylammonium trifluoroacetate, N,N,N-trialkyl-N-(meth)acryloylaminoalkylammonium heptafluorobutyrate, N,N,N-trialkyl-N-(meth)acryloylaminoalkylammonium trifluoromethanesulfonate, N,N,N-trialkyl-N-(meth)acryloylaminoalkylammonium perfluorobutanesulfonate, N,N,N-trialkyl-N-(meth)acryloylaminoalkylammonium bis(trifluoromethanesulfonyl)imide, N,N,N-trialkyl-N-(meth)acryloylaminoalkylammonium bis(pentafluoroethanesulfonyl)imide, N,N,N-trialkyl-N-(meth)acryloylaminoalkylammonium tris(trifluoromethanesulfonyl)imide, N,N,N-trialkyl-N-(meth)acryloylaminoalkylammonium hexafluorophosphate, N,N,N-trialkyl-N-(meth)acryloylaminoalkylammonium (trifluoromethanesulfonyl)trifluoroacetamide, N,N,N-trialkyl-N-(meth)acryloylaminoalkylammonium dicyanamide, N,N,N-trialkyl-N-(meth)acryloylaminoalkylammonium thiocyanate, and the like.

Further, the alkyl substituent described above is an alkyl group having preferably 1 to 16 carbon atoms, especially preferably 1 to 12 carbon atoms, and further preferably 1 to 6 carbon atoms.

Moreover, the reactive ionic liquid can be used without any particular limitation, but can be preferably a reactive ionic liquid represented by the following general formula (1) and/or (2). The polymer (B) containing as a monomer unit the reactive ionic liquid represented by the following general formula (1) and/or (2) is more preferable because it is moderately compatible to the polymer (A), is antistatic, and is able to suppress an increase in high-speed peeling strength. In addition, since the reactive ionic liquid is a liquid (liquid form) at any temperature within a range of 0 to 150° C., a non-volatile melt salt, and transparent, the resulting pressure-sensitive adhesive composition shows satisfactory antistatic properties (high conductivity), heat resistance (thermal stability), transparency, and low staining properties, because of which such a composition is useful.

CH₂═C(R¹)COOZX⁺Y⁻ (1)

CH₂═C(R¹)CONHZX⁺Y⁻ (2)

In the formulae (1) and (2), R¹ is a hydrogen atom or a methyl group, X⁺ is a cation moiety, and Y⁻ is an anion. Z represents an alkylene group having 1 to 3 carbon atoms.

The cation moiety (X⁺) constituting the reactive ionic liquid represented by the general formula (1) and/or (2) includes a quaternary ammonium group, an imidazolium group, a pyridinium group, a piperidinium group, a pyrrolidinium group, a pyrrole group, a quaternary phosphonium group, a trialkylsulfonium group, a pyrazolium group, a guanidium group, and the like. Among these, in particular, the quaternary ammonium group is a preferred embodiment for the electronic/optical applications because it is excellent in transparency. Further, since the quaternary ammonium group does not have an unsaturated bond other than the polymerizable functional group in the molecule, resulting in difficulty to inhibit the general radical polymerization reaction during ultraviolet (UV) curing, and is estimated to have a high curing property, such a quaternary ammonium group is suitable for the formation of an antistatic layer.

Specific examples of the quaternary ammonium group include a trimethylammonium group, a triethylammonium group, a tripropylammonium group, a methyldiethylammonium group, an ethyldimethylammonium group, a methyldipropylammonium group, a dimethylbenzylammonium group, a diethylbenzylammonium group, a methyldibenzylammonium group, an ethyldibenzylammonium group, and the like. In particular, the trimethylammonium group and the methylbenzylammonium group are preferred embodiments among others, in view of the fact that inexpensive industrial materials are easily obtained.

In the anion (moiety) (Y) constituting the reactive ionic liquid represented by the general formula (1) and/or (2), examples of such anions include SCN⁻, BF₄⁻, PF₆⁻, NO₃⁻, CH₃COO⁻, CF₃COO⁻, CH₃SO₃⁻, CF₃SO₃⁻, (FSO₂)₂N⁻, CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂) (CF₃CO)N⁻, B(CN)₄⁻, C(CN)₃⁻, N(CN)₂⁻, CH₃OSO₃⁻, C₂H₅OSO₃⁻, C₄H₉OSO₃⁻, C₆H₁₃OSO₃⁻, C₈H₁₇OSO₃⁻, p-toluenesulfonate anion, 2-(2-methoxyethyl)ethyl sulfate anion, (C₂F₅)₃PF₃⁻, and the like, and in particular, an anion component containing a fluorine atom (fluorine-containing anion) is preferable because an ionic liquid having a low melting point and an excellent antistatic property can be obtained. Note that it is desirable not to use a chlorine ion, a bromine ion or the like as an anion in view of corrosive properties thereof.

Particularly preferred combinations of the cation (moiety) and the anion (moiety) constituting the reactive ionic liquid represented by the general formula (1) and/or (2) include acryloylaminopropyltrimethylammonium bis(trifluoromethanesulfonyl)imide, methacryloylaminopropyltrimethylammonium bis(trifluoromethanesulfonyl)imide, acryloylaminopropyldimethylbenzylammonium bis(trifluoromethanesulfonyl)imide, acryloyloxyethyltrimethylammonium bis(trifluoromethanesulfonyl)imide, acryloyloxyethyldimethylbenzylammonium bis(trifluoromethanesulfonyl)imide, methacryloyloxyethyltrimethylammonium bis(trifluoromethanesulfonyl)imide, acryloylaminopropyltrimethylammonium bis(fluorosulfonyl)imide, methacryloylaminopropyltrimethylammonium bis(fluorosulfonyl)imide, acryloylaminopropyldimethylbenzylammonium bis(fluorosulfonyl)imide, acryloyloxyethyltrimethylammonium bis(fluorosulfonyl)imide, acryloyloxyethyldimethylbenzylammonium bis(fluorosulfonyl)imide, methacryloyloxyethyltrimethylammonium bis(fluorosulfonyl)imide, acryloylaminopropyltrimethylammonium trifluoromethanesulfonate, methacryloylaminopropyltrimethylammonium trifluoromethanesulfonate, acryloylaminopropyldimethylbenzylammonium trifluoromethanesulfonate, acryloyloxyethyltrimethylammonium trifluoromethanesulfonate, acryloyloxyethyldimethylbenzylammonium trifluoromethanesulfonate, methacryloyloxyethyltrimethylammonium trifluoromethanesulfonate, and the like.

The content of the reactive ionic liquid is preferably 10 to 99% by mass, more preferably 15 to 98% by mass, especially preferably 20 to 97% by mass, based on the total constituent units (total monomer units (components): 100% by mass) of the (meth)acryl-based polymer. If the blending ratio of the reactive ionic liquid is within the above range, excellent antistatic properties, transparency, heat resistance (thermal stability), and low staining properties are exhibited, because of which such a range is desirable.

The general synthetic method for the reactive ionic liquid is not particularly limited as long as it allows production of the target ionic liquid. In general, there can be employed a quaternarization/ion-exchange method, direct quaternarization method, carbonate-based quaternarization method, hydroxylation method, acid ester method, complex formation method, neutralization method or the like, such as those described in the literatures “Ionic Liquids—Front Line of Development and Future Outlook—” [published by CMC Publishing Co., Ltd.], “Polymer, vol. 52, pp. 1469-1482 (2011)”, and “Most Advanced Material Systems, One Point 2, Ionic Liquid” [published by Kyoritsu Shuppan Co., Ltd.].

[(Meth)acryl-Based Polymer (b)]

(Meth)acryl-based polymers (b) as a preferable specific example of the polymer (B) will be described below in detail.

As the (meth)acryl-based polymer (b), an alkyl (meth)acrylate can be used and a more preferred embodiment is to use an alkyl (meth)acrylate having an alkyl group of 1 to 14 carbon atoms. One or more kinds of the alkyl (meth)acrylates can be used.

Specific examples of the alkyl (meth)acrylate having an alkyl group of 1 to 14 carbon atoms includes, for example, methyl (meth)acrylate, ethyl (meth)acrylate, n-butyl (meth)acrylate, s-butyl (meth)acrylate, t-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, etc.

The content of the alkyl (meth)acrylate as a monomer unit (component) is preferably 0 to 90% by mass, more preferably 30 to 85% by mass, further preferably 50 to 80% by mass, based on the total constituent units (total monomer units (components): 100% by mass) of the (meth)acryl-based polymer (b). The monomer unit (component) within the above range is preferable from the viewpoint of obtaining the compatibility with the polymer (A).

As the other polymerizable monomer other than the alkyl (meth)acrylate, other polymerizable monomer unit (component) (copolymerizable monomer) that is copolymerizable with the alkyl (meth)acrylate may be contained as needed, for the purpose of modifying cohesive strength and crosslinking properties, and the like.

The (meth)acryl-based polymer (b) contains preferably a monomer having a polyoxyalkylene skeleton as the copolymerizable monomer, and such a monomer having a polyoxyalkylene skeleton is more preferably a reactive monomer containing alkylene oxide groups having an average addition mole number of 3 to 100 of the oxyalkylene units. By containing a monomer having the polyoxyalkylene skeleton in the (meth)acryl-based polymer (b), an ion conductivity of the reactive ionic liquid is improved and this is desirable.

In addition, the content of the reactive monomer containing an alkylene oxide with an average addition mole number of 3 to 100 of the oxyalkylene unit is preferably 1 to 80% by mass, more preferably 2 to 50% by mass, based on the total constituent units (total monomer units (components): 100% by mass) of the (meth)acryl-based polymer (b). The monomer unit (component) within the above range is preferable from the viewpoint of an improved ionic conductivity of the reactive ionic liquid.

The average addition mole number of oxyalkylene units to the alkylene oxide group-containing reactive monomer is preferably from 3 to 100, more preferably from 4 to 80, particularly preferably from 5 to 50, in view of compatibility with the polymer (A). If the average addition mole number is 3 or more, an effect of reducing staining of an adherend (object to be protected) will tend to be efficiently achieved. If the average addition mole number is more than 100, the interaction with the polymer (A) can be so strong that the pressure-sensitive adhesive composition can undesirably form a gel, which tends to make the coating difficult. The end of the oxyalkylene chain may be maintained as a hydroxyl group or substituted with other functional groups.

As the alkylene oxide group-containing reactive monomer, the same monomers as those in the detailed description of the polymer (A) ((meth)acryl-based polymer (a)) can be used.

As the other polymerizable monomer unit (copolymerizable monomer) other than the alkylene oxide group-containing reactive monomer, the same monomers (carboxyl group-containing monomer, hydroxyl group-containing monomer, polyfunctional monomer, etc.) as those in the detailed description of the polymer (A) ((meth)acryl-based polymer (a)) can be used. The blending amount of the copolymerizable monomer is not particularly limited, but is preferably 0.1 to 50% by mass, more preferably 0.5 to 40% by mass, further preferably 1 to 30% by mass, based on the total amount of the monomer unit (component) for preparing the (meth)acryl-based polymer (b). By containing the copolymerizable monomer in an amount of 0.1% by mass or more, reduction of cohesive strength of the pressure-sensitive adhesive (pressure-sensitive adhesive layer, pressure-sensitive adhesive sheet) formed of the pressure-sensitive adhesive composition is prevented and staining at the time of peeling off from an adherend can also be avoided. Further, by containing the copolymerizable monomer in an amount of 50% by mass or less, it is also possible to prevent the reduction of compatibility with the polymer (A) and suppress the increase in the adhesive strength at the time of high-speed peeling.

The polymerization method for the polymer (B) ((meth)acryl-based polymer (b)) containing, as the monomer unit (component), a reactive ionic liquid used in the present invention is not particularly limited, but the same methods as those described in detail for the polymer (A) ((meth)acryl-based polymer (a)) can be used. As is the case in the polymer (A) ((meth)acryl-based polymer (a)), the polymer obtained may be any of random copolymers, block copolymers, alternating copolymers, graft copolymers, and the like. As a polymerization initiator used for polymerization, the same initiator as described in detail for the polymer (A) ((meth)acryl-based polymer (a)) can be used.

The same chain transfer agent as detailed in the polymer (A) ((meth)acryl-based polymer (a)) can be used to adjust the inherent viscosity of (B) ((meth)acryl-based polymer (b)).

The blending amount of the chain transfer agent is not particularly limited, but the chain transfer agent is usually contained in an amount within a range of preferably 0.1 to 20 parts by mass, more preferably 0.2 to 15 parts by mass, and further preferably 0.3 to 10 parts by mass, based on 100 parts by mass of the monomer. By adjusting the blending amount of the chain transfer agent in such a way, a polymer (B) ((meth)acryl-based polymer (b) having a desired intrinsic viscosity can be obtained. Note that the chain transfer agent can be used alone or in combination of two or more thereof.

### [Pressure-Sensitive Adhesive Composition]

The pressure-sensitive adhesive composition of the present invention contains, as essential components, the polymer (A) and the polymer (B).

The blending amount of the polymer (B) is preferably 0.05 to 30 parts by mass, more preferably 0.1 to 25 parts by mass, further preferably 0.5 to 20 parts by mass, especially preferably 2.5 to 15 parts by mass, based on 100 parts by mass of the polymer (A). If the polymer (B) is blended (added) in an amount exceeding 30 parts by mass, it is not preferable because the cohesive strength of the pressure-sensitive adhesive layer that is formed of the pressure-sensitive adhesive composition of the present invention is reduced to cause a risk of undesirable staining to an adherend. Further, if the blending amount of the polymer (B) is less than 0.05 parts by mass, the antistatic properties of the pressure-sensitive adhesive layer are not sufficient.

### [Crosslinking Agent]

Examples of the crosslinking agent used for forming the pressure-sensitive adhesive layer include isocyanate compounds, epoxy compounds, melamine-based resins, aziridine derivatives, oxazoline crosslinking agents, silicone crosslinking agents, silane crosslinking agents, and metal chelate compounds. Among them, the isocyanate compounds and epoxy compounds are preferably employed mainly from the viewpoint of obtaining moderate cohesive strength, and the isocyanate compounds (isocyanate-based crosslinking agents) are particularly preferred. These compounds may be used alone or in combination of two or more thereof.

Examples of the isocyanate compound (isocyanate-based crosslinking agent) include, for example, lower aliphatic polyisocyanates, such as butylene diisocyanate, hexamethylene diisocyanate, etc.; alicyclic isocyanates, such as cyclopentylene diisocyanate, cyclohexylene diisocyanate, isophorone diisocyanate, etc.; aromatic diisocyanates, such as 2,4-tolylene diisocyanate, 4,4′-diphenylmethane diisocyanate, xylylene diisocyanate, etc.; isocyanate adducts, such as trimethylolpropane/tolylene diisocyanate trimer adduct (trade name: Coronate L, manufactured by Nippon Polyurethane Industry Co., Ltd.), trimethylolpropane/hexamethylene diisocyanate trimer adduct (trade name: Coronate HL, manufactured by Nippon Polyurethane Industry Co., Ltd.), an isocyanurate form of hexamethylene diisocyanate (trade name: Coronate HX, manufactured by Nippon Polyurethane Industry Co., Ltd.); and the like. Alternatively, compounds having one or more isocyanate groups and one or more unsaturated bonds in the molecule, specifically such as 2-isocyanatoethyl (meth)acylate, etc., can also be used as the isocyanate-based crosslinking agent. These compounds may be used alone or as a mixture of two or more thereof.

Examples of the epoxy compound include, for example, bisphenol A, epichlorohydrin type epoxy-based resin, ethylene glycidyl ether, polyethylene glycol diglycidyl ether, glycerine diglycidyl ether, glycerine triglycidyl ether, 1,6-hexanediol glycidyl ether, trimethylolpropane triglycidyl ether, diglycidyl aniline, diamineglycidylamine, N,N,N′,N′-tetraglycidyl-m-xylenediamine (trade name: TETRAD-X, manufactured by Mitsubishi Gas Chemical Co., Inc.), 1,3-bis(N,N-diglycidylaminomethyl)cyclohexane (trade name: TETRAD-C, manufactured by Mitsubishi Gas Chemical Co., Inc.), and the like. These compounds may be used alone or as a mixture of two or more thereof.

Examples of the melamine-based resin include hexamethylol melamine and the like. Further, examples of the aziridine derivative include commercially available products, such as “HDU”, “TAZM”, and “TAZO” (trade names) manufactured by Sogo Pharmaceutical Co., Ltd. These compounds may be used alone or as a mixture of two or more thereof.

In the metal chelate compound, examples of the metal component include aluminum, iron, tin, titanium, nickel, etc., and examples of the chelate component include acetylene, methyl acetoacetate, ethyl lactate, etc. These compounds may be used alone or as a mixture of two or more thereof.

The content of the crosslinking agent is preferably 0.01 to 30 parts by mass, more preferably 0.1 to 20 parts by mass, further preferably 0.5 to 15 parts by mass, and especially preferably 0.5 to 10 parts by mass, based on 100 parts by mass of the polymer (A). If the content of such a crosslinking agent is less than 0.01 parts by mass, there are sometimes the cases where the cohesive strength of the pressure-sensitive adhesive (layer) becomes smaller due to insufficient formation of crosslinkages by a crosslinking agent, resulting in failure to obtain a sufficient heat resistance. On the other hand, if the content is more than 30 parts by mass, gelatinous foreign substances are generated in the pressure-sensitive adhesive composition because the crosslinking reaction proceeds in a short time, and thus there is a tendency to cause poor appearance.

Further, it is possible to contain a crosslinking catalyst for effectively promoting any one of the crosslinking reactions described above. As such a crosslinking catalyst, for example, a tin catalyst (in particular, dioctyltin dilaurate) can be preferably used. The blending amount of the crosslinking catalyst (e.g., tin-based catalyst, such as dioctyltin dilaurate) is not particularly limited, but the amount may be, for example, within a range of 0.005 to 1 part by mass, based on 100 parts by mass of the polymer (A).

In addition, in the present invention, a polyfunctional monomer having two or more radiation-reactive unsaturated bonds may be added as a crosslinking agent to the pressure-sensitive adhesive composition. In this case, the pressure-sensitive adhesive composition may be crosslinked by the radiation exposure. As the polyfunctional monomer having two or more radiation-reactive unsaturated bonds in a molecule, there are exemplified polyfunctional monomer components having two or more radiation-reactive groups of one or two or more kinds selected from vinyl, acryloyl, methacryloyl, and vinylbenzyl groups, which can be crosslinked (cured) by the radiation exposure. The polyfunctional monomer that may be preferably used generally has 10 or less radiation-reactive unsaturated bonds. These compounds may be used alone or as a mixture of two or more thereof.

Specific examples of the polyfunctional monomer having two or more radiation-reactive unsaturated bonds include, for example, ethylene glycol di(meth)acrylate, diethylene glycol di(meth)acrylate, tetraethylene glycol di(meth)acrylate, neopentylglycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinylbenzene, and N,N′-methylenebisacrylamide, etc.

The blending amount of the polyfunctional monomer may be appropriately selected depending on the balance with the polymer (A) to be crosslinked. In order to achieve sufficient heat resistance, 0.1 to 30 parts by mass of the polyfunctional monomer is preferably blended, based on 100 parts by mass of the polymer (A). Also in view of flexibility, it is preferred to blend the polyfunctional monomer in an amount of 10 parts by mass or less based on 100 parts by mass of the polymer (A).

Examples of radiation include ultraviolet ray, laser ray, α ray, β ray, γ ray, X-ray, and electron beam. From a viewpoint of controlling property and better handling property and a cost, ultraviolet ray is suitably used. More preferably, ultraviolet ray having a wavelength of 200 to 400 nm is used. Ultraviolet ray can be irradiated using an appropriate light source such as a high pressure mercury lamp, a micro-wave excitation-type lamp, and a chemical lamp. When ultraviolet ray is used as irradiation, a photopolymerization initiator is added to an acryl pressure-sensitive adhesive layer.

The photopolymerization initiator depends on a kind of a radiation-reactive component, and may be a substance which produces a radical or a cation by irradiating ultraviolet ray having an appropriately wavelength which can trigger the polymerization reaction.

Example of the photoradical polymerization initiator include benzoins such as benzoin, benzoin methyl ether, benzoin ethyl ether, methyl o-benzoylbenzoate-p-benzoin ethyl ether, benzoin isopropyl ether, and α-methylbenzoin, acetophenes such as benzylmethylketal, trichloroacetophenone, 2,2-diethoxyacetophenone, and 1-hydroxycyclohexyl phenyl ketone, propiophenones such as 2-hydroxy-2-methylpropiophenone, and 2-hydroxy-4′-isopropyl-2-methylpropiophenone, benzophenones such as benzophenone, methylbenzophenone, p-chlorobenzophenone, and p-dimethylaminobenzophenone, thioxanthons such as 2-chlorothioxanthon, 2-ethylthioxanthon, and 2-isopropylthioxanthon, acylphosphine oxides such as bis(2,4,6-trimethylbenzoyl)-phenylphosphine oxide, 2,4,6-trimethylbenzoyldiphenylphosphine oxide, and (2,4,6-trimethylbenzoyl)-(ethoxy)-phenylphosphine oxide, benzil, dibenzsuberone, and α-acyloximeether. These compounds may be used alone or in a mixture of two or more.

Examples of a photocation polymerization initiator include onium salts such as an aromatic diazonium salt, an aromatic iodonium salt, and an aromatic sulfonium salt, organometallic complexes such as an ion-allene complex. a titanocene complex, and an aryl silanol-aluminum complex, nitrobenzyl ester, sulfonic acid derivative, phosphoric acid ester, phenolsulfonic acid ester, diazonaphthoquinone, and N-hydroxymidosulfonate. These compounds may be used alone or in a mixture of two or more.

The photopolymerization initiator is blended in an amount usually within a range of 0.1 to 10 parts by mass, preferably within a range of 0.2 to 7 parts by mass, based on 100 parts by mass of the polymer (A). If the amount of the photopolymerization initiator is within the above range, it is easy to control the polymerization and such a range is preferable for obtaining a suitable molecular weight.

Photoinitiation aids such as amines may also be used in combination. Examples of such photoinitiation aids include, for example, 2-dimethylaminoethyl benzoate, dimethylaminoacetophenone, ethyl p-dimethylaminobenzoate, and isoamyl p-dimethylaminobenzoate. These compounds may be used alone or as a mixture of two or more thereof. The photoinitiation aid is blended in an amount of preferably 0.05 to 10 parts by mass, more preferably 0.1 to 7 parts by mass, based on 100 parts by mass of the polymer (A). If the amount of the photoinitiation aid is within the above range, it is easy to control the polymerization and such a range is preferable for obtaining a suitable molecular weight.

When the photopolymerization initiator is added as an optional component as described above, the pressure-sensitive adhesive layer may be obtained by applying the pressure-sensitive adhesive composition to one side or both sides of a substrate film and then irradiating the coating with light. Usually, the pressure-sensitive adhesive layer is obtained by performing the photopolymerization through irradiation with about 200 to 4000 mJ/cm² of ultraviolet rays that have an illuminance of 1 to 200 mW/cm² under a wavelength of 300 to 400 nm.

It is preferable to contain a conductive agent (antistatic agent) in the pressure-sensitive adhesive composition. As the conductive agent (antistatic agent), an ionic compound or an ion conductive polymer is preferably contained, and an ionic compound such as an alkali metal salt and an ionic liquid is more preferably contained. The ionic compound can be contained as an additive separately without the reaction with the reactive ionic liquid and can exhibit more excellent antistatic properties. Thus, this is a preferable embodiment. In addition, since the ionic compound easily interacts with the reactive ionic liquid incorporated into the skeleton of the polymer (B), such a compound can suppress a concern about the bleeding out and is preferable because of its excellent low staining property.

The content of the conductive agent used in the present invention is preferably 0 to 10 parts by mass, more preferably 0.01 to 5 parts by mass, further preferably 0.1 to 3 parts by mass, based on 100 parts by mass of the polymer (A) contained in the pressure-sensitive adhesive composition. If such a content exceeds 10 parts by mass, there is a risk of occurrence of undesirable bleeding out.

The pressure-sensitive adhesive composition disclosed herein may contain a compound that exhibits keto-enol tautomerism. By containing such a compound, an excessive viscosity increase or gelling can be suppressed in the pressure-sensitive adhesive composition after incorporating the crosslinking agent thereinto so that an effect of prolonging a pot life of the composition can be achieved. When at least an isocyanate compound is used as the crosslinking agent, it is particularly meaningful to contain a compound that exhibits keto-enol tautomerism. This technology can be preferably used when the pressure-sensitive adhesive composition is in the form of an organic solvent solution or is in a solvent-free form.

Various β-dicarbonyl compounds can be used as the compound that exhibits keto-enol tautomerism. Specific examples thereof include, for example, β-diketones such as acetylacetone, 2,4-hexanedione, 3,5-heptanedione, 2-methylhexane-3,5-dione, 6-methylheptane-2,4-dione, 2,6-dimethylheptane-3,5-dione, etc.; acetoacetate esters such as methyl acetoacetate, ethyl acetoacetate, isopropyl acetoacetate, tert-butylacetoacetate, etc.; propionyl acetate esters such as ethyl propionylacetate, isopropyl propionylacetate, tert-butylpropionylacetate, etc.; isobutyryl acetates such as ethyl isobutyrylacetate, isopropyl isobutyrylacetate, tert-butyl isobutyrylacetate, etc.; and malonic acid esters such as methyl malonate, ethyl malonate, etc. Preferred compounds among the foregoing are acetylacetone and acetoacetate esters. The compound that exhibits keto-enol tautomerism may be used alone or in combinations of two or more thereof.

The content of the compound that exhibits keto-enol tautomerism can be, for example, 0.1 to 20 parts by mass, more preferably 0.5 to 15 parts by mass, further preferably 1 to 10 parts by mass, based on 100 parts by mass of the polymer (A). If the content of the compound is less than 0.1 parts by mass, a sufficient use effect is hardly exhibited in some cases. On the other hand, when the compound is used in an amount of more than 20 parts by mass, it remains in the pressure-sensitive adhesive layer, resulting in the deterioration of antistatic properties in some cases.

Further, the pressure-sensitive adhesive composition may contain other known additives, for example, a powder of a coloring agent, a pigment, or the like, a surfactant, a plasticizer, a tackifier, a low-molecular-weight polymer, a surface lubricant, a leveling agent, an antioxidant, a corrosion inhibitor, a light stabilizer, an ultraviolet absorber, a polymerization inhibitor, a silane coupling agent, an inorganic or organic filler, a metal powder, granules, foils, and others, which may be appropriately added depending on the intended use.

A preferred embodiment of the pressure-sensitive adhesive composition is achieved by forming a liquid composition (pressure-sensitive adhesive composition, pressure-sensitive adhesive solution) in which the polymer (A), the polymer (B), and other components (crosslinking agent, conductive agent, etc.) optionally used are dispersed or dissolved in a suitable solvent, on at least one side of a substrate film. For example, there may be preferably employed a method in which the liquid composition (pressure-sensitive adhesive composition, pressure-sensitive adhesive solution) is applied to one side of the substrate film, dried, and optionally subjected to a curing treatment (heat treatment, ultraviolet treatment, etc.).

The solvents constituting the pressure-sensitive adhesive composition are preferably those that may stably dissolve or disperse the components (raw materials) used in the formation of the pressure-sensitive adhesive layer. As such a solvent, an organic solvent, water, or a mixed solvent thereof can be used. The organic solvent that can be used is selected from one or two or more members including, for example, esters such as ethyl acetate, butyl acetate, 2-hydroxyethyl acetate, etc.; ketones such as methyl ethyl ketone, acetone, cyclohexanone, methyl isobutyl ketone, diethyl ketone, methyl-n-propyl ketone, acetylacetone, etc.; cyclic ethers such as tetrahydrofuran (THF), dioxane, etc.; aliphatic or alicyclic hydrocarbons such as n-hexane, cyclohexane, etc.; aromatic hydrocarbons such as toluene, xylene, etc.; aliphatic or alicyclic alcohols such as methanol, ethanol, n-propanol, isopropanol, cyclohexanol, etc.; glycol ethers such as ethylene glycol monomethyl ether, ethylene glycol monoethyl ether, diethylene glycol monoethyl ether, etc.; glycol ether acetates such as diethylene glycol monomethyl ether acetate, diethylene glycol monoethyl ether acetate, etc.; and the like.

Application and coating of the pressure-sensitive adhesive composition can be performed by using a commonly used coater, including, for example, a gravure roll coater, a reverse roll coater, a kiss roll coater, a dip roll coater, a bar coater, a knife coater, a spray coater, and the like. A pressure-sensitive adhesive layer may be formed by directly providing the pressure-sensitive adhesive composition to the substrate film, or a pressure-sensitive adhesive layer formed on a release liner may be transferred to the substrate.

### [Pressure-Sensitive Adhesive Layer]

The pressure-sensitive adhesive layer of the present invention is preferably formed from the pressure-sensitive adhesive composition described above. Since such a pressure-sensitive adhesive composition is used, the resulting pressure-sensitive adhesive layer is excellent in antistatic properties, adhesive properties, repeelability, and transparency.

In the pressure-sensitive adhesive layer, the gel fraction (ratio of the solvent-insoluble component) is preferably within a range of 85.00 to 99.95% by mass, more preferably within a range of 86.00 to 99.00% by mass. If the gel fraction (ratio of the solvent-insoluble component) is less than 85.00% by mass, the pressure-sensitive adhesive layer is insufficient in cohesive strength and thus may stain an adherend (object to be protected) when peeled off. Conversely, if the gel fraction thereof is more than 99.95% by mass, the pressure-sensitive adhesive layer has too large cohesive strength and thus may be deteriorated in terms of sufficient adhesive strength (high-speed peeling strength, low-speed peeling strength). A method of evaluating the gel fraction will be described later.

The thickness of the pressure-sensitive adhesive layer is not particularly limited, but is set to be usually, for example, within a range of 3 to 100 μm, preferably within a range of 5 to 80 μm, further preferably 10 to 50 μm, thereby to achieve good adherability. If the thickness of the pressure-sensitive adhesive layer is less than 3 μm, the adherability becomes insufficient, and accordingly there are sometimes the cases where lifting and peeling off are caused. On the other hand, if the thickness thereof is more than 100 μm, the high-speed peeling strength becomes large, and accordingly there are sometimes the cases where the peeling workability is decreased.

The pressure-sensitive adhesive sheet according to the present invention is provided with a pressure-sensitive adhesive layer made of the pressure-sensitive adhesive composition and formed on at least one side of a substrate film. The pressure-sensitive adhesive sheet is made by fixedly providing such a pressure-sensitive adhesive layer on at least one side of the substrate film, i.e. without an intention to separate the pressure-sensitive adhesive layer from the above substrate film. The concept of the pressure-sensitive adhesive sheet described herein can involve those referred to as a pressure-sensitive adhesive tape, a pressure-sensitive adhesive film, and a pressure-sensitive adhesive label, etc. In addition, the pressure-sensitive adhesive sheet may be cut into an appropriate shape, or may be subjected to a punching process, etc., in accordance with its use or application. Note that the pressure-sensitive adhesive layer is not limited to one that is continuously formed, but may be one that is formed into a regular or random pattern, such as a dot shape and a stripe shape.

It is also possible to bond a release liner on the pressure-sensitive adhesive layer surface of the pressure-sensitive adhesive sheet of the present invention, a surface protective sheet which will be described later, and an optical surface protective sheet, for the purpose of protecting the adhesive surface, if necessary.

As a material constituting the release liner, there are, for example, a paper and a plastic film, and a plastic film is suitably used from the viewpoint of excellent surface smoothness. The film is not particularly limited as long as it is a film capable of protecting the pressure-sensitive adhesive layer. Examples of the film include, for example, a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinylacetate copolymer film, etc.

The thickness of the release liner is within a range of usually about 5 to 200 μm, preferably about 10 to 100 μm. When the thickness is within the above range, workability in bonding to the pressure-sensitive adhesive layer and that in peeling off therefrom are both excellent, and this feature is preferable. The release liner may also be subjected to: a release treatment and antifouling treatment by a silicone-based, a fluorine-based, a long-chain alkyl-based, a fatty acid amide-based release agent, or silica powder; and an antistatic treatment, such as coating type treatment, kneading type treatment, deposition type treatment, and the like, if necessary.

### [Substrate Film]

The substrate film used can be appropriately selected from, for example:

plastic films including: polyolefin films (e.g. polyethylene, polypropylene, poly-1-butene, poly-4-methyl-1-pentene, ethylene/propylene copolymer, ethylene/1-butene copolymer, ethylene/vinyl acetate copolymer, ethylene/ethyl acrylate copolymer, ethylene/vinyl alcohol copolymer, etc.), polyester films (e.g. polyethylene terephthalate, polyethylene naphthalate, polybutylene terephthalate, etc.), polyacrylate film, polystyrene film, polyamide films (e.g. nylon 6, nylon 6,6, partially aromatic polyamide, etc.), polyvinyl chloride film, polyvinylidene chloride film, and polycarbonate film, etc.;

foam substrates, such as polyurethane foam and polyethylene foam, etc.;

paper, such as craft paper, crepe paper, and Japanese paper, etc.;

cloth, such as cotton cloth and staple fiber cloth, etc.;

nonwoven cloth, such as polyester nonwoven fabric and vinylon nonwoven fabric, etc.;

metallic foils, such as aluminum foil and copper foil, etc.; and the like. When the pressure-sensitive adhesive sheet according to the present invention is used as the later-described surface protective sheet, it is preferable to use a plastic film, such as a polyolefin film, a polyester film, and a polyvinyl chloride film for a substrate film. Further, when the pressure-sensitive adhesive sheet of the present invention is used as a surface protective sheet for optical use, it is preferable to use a polyolefine film, a polyethylene terephthalate film, a polybutylene terephthalate film, and a polyethylene naphthalate film. As the plastic films, any of a non-oriented film and an oriented (uniaxially oriented or biaxially oriented) film can be used.

The substrate film may be subjected to a release treatment and an antifouling treatment with a silicone-based, fluorine-based, long chain alkyl-based, or fatty acid amide-based releasing agent, or a silica powder, to an easy adhesion treatment such as acid treatment, alkali treatment, primer treatment, corona treatment, plasma treatment, ultraviolet ray treatment, etc., or to an antistatic treatment (e.g. coating type, kneading type, deposition type, etc.), if necessary.

The thickness of the substrate film can be appropriately selected depending on the purposes, but it is generally about 5 to 200 μm (typically 10 to 100 μm).

A more preferred embodiment is to use an antistatic-treated plastic film as the substrate film for use in the pressure-sensitive adhesive sheet in accordance with the present invention. By performing an antistatic treatment thereon, occurrence of static electricity can be prevented, and accordingly it is useful in the technical field related to optical and electronic components in which electrostatic charge poses a serious problem. The antistatic treatment to be performed on a plastic film is not particularly limited, but a method of providing an antistatic layer on at least one side of the plastic film which is generally used or a method of kneading a kneading type antistatic agent into the plastic film. Examples of the method of providing an antistatic layer on at least one side of the film include a method of coating an antistatic resin made of an antistatic agent and a resin component, a conductive polymer, or a conductive resin containing a conductive substance and a method of depositing or plating a conductive substance.

Examples of the antistatic agent contained in the antistatic resin include, for example, a cation-type antistatic agent having a cationic functional group such as a quaternary ammonium salt, a pyridinium salt, and a primary, secondary or tertiary amino group; an anion-type antistatic agent having an anionic functional group such as a sulfonic acid salt, a sulfuric acid ester salt, a phosphonic acid salt, and a phosphoric acid ester salt; an amphoteric-type antistatic agent such as alkylbetain and a derivative thereof, imidazoline and a derivative thereof, and alanine and a derivative thereof; a nonion-type antistatic agent such as an aminoalcohol and a derivative thereof, glycerin and a derivative thereof, and polyethylene glycol and a derivative thereof; and an ionic electrically conductive polymer obtained by polymerizing or copolymerizing a monomer having the aforementioned cation-type, anion-type, or amphoteric-type ionic conductive group. These compounds may be used alone, or as a mixture of two or more thereof.

Specifically, examples of the cation-type antistatic agent include a (meth)acrylate copolymer having a quaternary ammonium group such as an alkyl trimethylammonium salt, acyloylamidopropyltrimethylammonium methosulfate, an alkylbenzylmethylammonium salt, acyl choline chloride, and polydimethylaminoethyl methacrylate, a styrene copolymer having a quaternary ammonium group such as polyvinylbenzyltrimethylammonium chloride, and a diallylamine copolymer having a quaternary ammonium group such as polydiallyldimethylammonium chloride. The compounds may be used alone, or two or more kinds may be used by mixing.

Examples of the anion-type antistatic agent include an alkyl sulfonic acid salt, an alkylbenzenesulfonic acid salt, an alkyl sulfate ester salt, an alkyl ethoxy sulfate ester salt, an alkyl phosphate ester salt, and a sulfonic acid group-containing styrene copolymer. These compounds may be used alone, or two or more kinds may be used by mixing.

Examples of the amphoteric-type antistatic agent include alkylbetain, alkylimidazoliumbetain, and carbobetaingrafted copolymer. These compounds may be used alone, or two or more kinds may be used by mixing.

Examples of the nonion-type antistatic agent include fatty acid alkylolamide, di(2-hydroxyethyl)alkylamine, polyoxyethylenealkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylenediamine, a copolymer consisting of polyether, polyester and polyamide, and methoxypolyethyleneglycol (meth)acrylate. These compounds may be used alone, or two or more kinds may be used by mixing.

Examples of the conductive polymer include, for example, polyaniline, polypyrrole, polythiophene, and the like.

Examples of the conductive substance include tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and an alloy or a mixture thereof.

As the resin component used for the antistatic resin and the conductive resin, there are employed general-purpose resins such as polyester, acryl, polyvinyl, urethane, melamine and epoxy. In the case of a polymer-type antistatic agent, it is not necessary to contain a resin component. In addition, the antistatic resin component may contain a compound as a crosslinking agent, such as a methylolated or alkylolated melamine-based compound, a urea-based compound, a glyoxal-based compound, an acrylamide-based compound, an epoxy compound, and an isocyanate-based compound.

The antistatic layer can be formed, for example, by a method in which the antistatic resin, the conductive polymer, or the conductive resin is diluted with a solvent, such as an organic solvent or water, and the solution is coated on a plastic film and then dried.

Examples of the organic solvent to be used for forming the antistatic layer include, for example, methyl ethyl ketone, acetone, ethyl acetate, tetrahydrofuran, dioxane, cyclohexanone, n-hexane, toluene, xylene, methanol, ethanol, n-propanol, and isopropanol, etc. These solvents can be used alone or as a mixture of two or more thereof.

As a coating method in formation of the antistatic layer, the known coating method is appropriately used, and examples include roll coating, gravure coating, reverse coating, roll brushing, spray coating, and air knife coating methods, and an immersing and curtain coating method.

The thickness of each of the antistatic resin layer, conductive polymer, and conductive resin is usually within a range of approximately 0.01 to 5 μm, and preferably within a range of approximately 0.03 to 1 μm.

Examples of the method of depositing or plating a conductive substance include, for example, vacuum deposition, sputtering, ion plating, chemical deposition, spray pyrolysis, chemical plating, electric plating methods, and the like.

The thickness of the conductive substance layer is usually within a range of 2 nm to 1000 nm, preferably within a range of 5 nm to 500 nm.

The antistatic agents described above are appropriately used as the kneading type antistatic agent. The blending amount of the antistatic agent is less than or equal to 20% by mass, and preferably within a range of 0.05 to 10% by mass, based on the total mass of the plastic film. A method of kneading the antistatic agent is not particularly limited, as far as the antistatic agent can be uniformly mixed into the resin to be used in the plastic film; and for example, a heating roll, a Banbury mixer, a pressure kneader, or a biaxial kneading machine can be used.

### [Pressure-Sensitive Adhesive Sheet]

The pressure-sensitive adhesive sheet according to the present invention has the properties (adherability) that the adhesive strength occurring at high-speed peeling is small (repeeling property) and that the adhesive strength occurring at low-speed peeling is sufficiently so large as not to cause a problem, such as lifting and peeling off.

The adhesive strength of the pressure-sensitive adhesive sheet occurring at low-speed peeling can be evaluated by a 180° peeling off adhesive strength test performed under the conditions in which the sheet is peeled off at a tensile speed of 0.3 m/min (low speed) and a peeling angle of 180°, and the adhesive strength of 0.04 N/25 mm or more is determined to be good. The adhesive strength is more preferably equivalent to or more than 0.06 N/25 mm, further preferably equivalent to or more than 0.08 N/25 mm. The upper limit of the 180° peeling off adhesive strength is not particularly demanded, but is usually 1.0 N/25 mm or less. The 180° peeling off adhesive strength test is performed according to the method and conditions described in the later-described Examples.

The adhesive strength of the pressure-sensitive adhesive sheet occurring at high-speed peeling can be evaluated by a 180° peeling off adhesive strength test performed under the conditions in which the sheet is peeled off at a tensile speed of 30 m/min (high speed) and a peeling angle of 180°, and the adhesive strength of 10 N/25 mm or less is determined to be good. The adhesive strength is more preferably equivalent to or less than 9 N/25 mm, further preferably equivalent to or less than 7 N/25 mm. The lower limit of the 180° peeling off adhesive strength is not particularly demanded, but is usually 0.05 N/25 mm or more. The 180° peeling off adhesive strength test is performed according to the method and conditions described in the later-described Examples.

The pressure-sensitive adhesive sheet of the present invention has an excellent antistatic property. The peeling electrification voltage is preferably 1.0 kV or less, more preferably 0.8 kV or less, especially preferably 0.6 kV or less (as an absolute value). If the peeling electrification voltage is within the above range, it is advantageous because dust collection due to static electricity and occurrence of electrostatic hazards of electronic components can be prevented. The measurement of the peeling electrification voltage is performed according to the method and conditions described in the later-described Examples.

The pressure-sensitive adhesive sheet according to the present invention has a property of having high transparency. The transparency of the pressure-sensitive adhesive sheet can be evaluated by a haze, and is particularly determined to be good when the haze is less than 10%. The haze is preferably less than 8.5%, more preferably less than 7%. The haze measurement is performed according to the method and conditions described in the later-described Examples.

Since the pressure-sensitive adhesive sheet of the present invention has the above properties, it is available as a repeelable pressure-sensitive adhesive sheet or as an antistatic pressure-sensitive adhesive sheet, using particularly the adhesive properties, repeelable properties, and antistatic properties.

Further, the pressure-sensitive adhesive sheet can be recommended to be used as a surface protective sheet (film) for protecting the surface of optical members, particularly such as polarizing plates, wavelength plates, optical compensation films, reflective sheets, and the like, and also can be used as an optical film with a surface protective sheet, wherein an optical surface protective sheet is bonded to the optical member.

Examples of the adherend (object to be protected) to which the surface protective sheet can be applied include: various resins, such as PE (polyethylene), PP (polypropylene), ABS (acrylonitrile-butadiene-styrene copolymer), SBS (styrene-butadiene-styrene block copolymer), PC (polycarbonate), PVC (vinyl chloride), and acryl-based resin (e.g. PMMA (polymethyl methacrylate resin); and automobiles (their body coatings), housing and building materials, and home electronic appliances, in which components made of metals, such as SUS (stainless steel) and aluminum, and glass, etc., are also included.

When the pressure-sensitive adhesive sheet according to the present invention is used as a surface protective sheet, the pressure-sensitive adhesive sheet can be used as it is. However, when the sheet is used particularly as a sheet for protecting surfaces, it is preferable, from the viewpoint of preventing the occurrence of scratches and stains, and from the processability, that a substrate film is a polyolefin film, a polyester film, or a polyvinyl chloride film each having a thickness within a range of 10 to 100 μm. It is also preferable that the thickness of the pressure-sensitive adhesive layer is made to be within a range of approximately 3 to 50 μm.

It is further preferable to use the pressure-sensitive adhesive sheet according to the present invention as an optical surface protective sheet to be used for protecting the surface of an optical film, because the sheet according to the present invention has a property of high transparency in addition to the adhesive property. Examples of the optical film to which the optical surface protective sheet according to the present invention can be applied include a polarizing plate, a wavelength plate, an optical compensation film, a light diffusing sheet, a reflective sheet, an anti-reflection sheet, a brightness enhancement film, and a transparent conductive film (ITO film), etc., which are to be used in image display devices, such as a liquid crystal display, a plasma display, and an organic EL display.

The pressure-sensitive adhesive sheet of the present invention can be used for: protecting optical films when they are shipped by a manufacturer of optical films, such as polarizing plates; protecting optical films when display devices (liquid crystal display modules) are manufactured by a manufacturer of image display devices, such as liquid crystal display devices; and further protecting optical films in various processes, such as punching process and cutting process.

When the pressure-sensitive adhesive sheet according to the present invention is used as an optical surface protective sheet, the pressure-sensitive adhesive sheet can be used as it is. However, when the sheet is used particularly as a sheet for protecting optical film surfaces, it is preferable, from the viewpoint of processability, transparency, and prevention of the occurrence of scratches and stains, that a substrate film is a polyolefin film, a polyethylene terephthalate film, a polybutylene terephthalate film, or a polyethylene naphthalate film each having a thickness within a range of 10 to 100 μm is used. In addition, it is preferable to adjust the thickness of the pressure-sensitive adhesive within a range of approximately 3 to 40 μm.

[Optical Film with Pressure-Sensitive Adhesive Sheet]

The optical film of the present invention is preferably an optical film with a pressure-sensitive adhesive sheet, in which the pressure-sensitive adhesive sheet (optical surface protective sheet) is bonded to the optical film. The optical film with the pressure-sensitive adhesive sheet of the present invention is made by bonding the pressure-sensitive adhesive sheet (optical surface protective sheet) to one or both sides of the optical film. The optical film with the pressure-sensitive adhesive sheet according to the present invention can prevent the occurrence of scratches or the adhesion of dirt or dust in/to optical films, when the optical films are shipped by an manufacturer of optical films, such as the polarizing plates; when display devices (liquid crystal display modules) are manufactured by a manufacturer of image display devices, such as liquid crystal display devices; and further in various processes, such as punching process and cutting process. An inspection can be carried out with the optical surface protective sheet bonded thereon, because the optical surface protective sheet has high transparency. Further, when the optical surface protective sheet becomes unnecessary, it can be easily peeled off without damaging the optical film or image display device.

### EXAMPLES

Hereinafter the present invention will be described in detail based on Examples, but these Examples are not intended to limit the present invention to them. Note that the components of the pressure-sensitive adhesive compositions of Examples 1 to 10 and Comparative Examples 1 to 2 are shown in Table 1 and the evaluation results are shown in Tablet. In addition, “parts” and “%” in the following description are expressed on a mass basis, unless otherwise indicated.

<Preparation of Polymer (A): (Meth)Acryl-Based Polymer (a)>

To a four-necked flask equipped with a stirring blade, a thermometer, a nitrogen gas inlet tube, a condenser and an addition funnel were charged 96 parts by mass of 2-ethylhexyl acrylate (2EHA), 4 parts by mass of 2-hydroxyethyl acrylate (HEA), 0.2 parts by mass of 2,2′-azobisisobutyronitrile as a thermal polymerization initiator, and 150 parts by mass of ethyl acetate. Then, nitrogen gas was introduced thereto while stirring the mixture gently, and polymerization was performed for 6 hours while maintaining the liquid temperature in the flask at around 65° C., thereby to prepare a (meth)acryl-based polymer (a) solution (40% by mass). The glass transition temperature of this (meth)acryl-based polymer (a), calculated from the Fox equation, was −68° C. and the weight average molecular weight was 550,000.

### <Preparation of Reactive Ionic Liquid (DMAEA-TFSI)>

To a 1 L-three necked flask were added 100 parts of 79% aqueous solution of (2-acryloyloxy)ethyltrimethylammonium chloride (DMAEA-Q, manufactured by Kohjin Co., Ltd.) and then, with stirring under heating at 60° C., a solution obtained by diluting 114 parts of potassium bis(trifluoromethane-sulfonyl) imide in 80 parts of ion-exchange water. After 2 hours, the oily lower layer was taken out from the two separated layers, washed 3 times with ion-exchange water, and a trace amount of remaining water was removed under reduced pressure to obtain 2-(acryloyloxy)ethyltrimethylammonium bis(trifluoromethane-sulfonyl)imide (DMAEA-TFSI).

### <Preparation of Reactive Ionic Liquid (DMAPAA-TFSI)>

To a 1 L-three necked flask were added 100 parts of 75% aqueous solution of (3-acrylamidopropyl)trimethylammonium chloride (DMAPAA-Q, manufactured by Kohjin Co., Ltd.) and then, with stirring under heating at 60° C., a solution obtained by diluting 116 parts of potassium bis(trifluoromethane-sulfonyl) imide in 80 parts of ion exchange water. After 2 hours, the oily lower layer was taken out from the two separated layers, washed 3 times with ion-exchange water, and a trace amount of remaining water was removed under reduced pressure to obtain (3-acrylamidopropyl)trimethylammonium bis(trifluoromethane-sulfonyl) imide (DMAPAA-TFSI).

<Preparation of Polymer (B): (Meth)Acryl-Based Polymer (b1)>

To a four-necked flask equipped with a stirring blade, a thermometer, a nitrogen gas inlet tube, a condenser and an addition funnel were added 150 parts by mass of ethyl acetate, 20 parts by mass of acryloxyethyltrimethylammonium bis(trifluoromethanesulfonyl) imide (DMAEA-TFSI), 80 parts by mass of 2-ethylhexyl acrylate, and 3.5 parts by mass of α-thioglycerol as a chain transfer agent. Then, the mixture was stirred at 70° C. for 1 hour under a nitrogen atmosphere and 0.2 parts by mass of 2,2′-azobisisobutyronitrile as a thermal polymerization initiator was added thereto. The mixture was allowed to react at 70° C. for 2 hours and then at 80° C. for 5 hours. The resulting (meth)acryl-based polymer (b1) was found to have an intrinsic viscosity of 0.032 (dL/g).

<Preparation of Polymer (B): (Meth)Acryl-Based Polymer (b2)>

To a four-necked flask equipped with a stirring blade, a thermometer, a nitrogen gas inlet tube, a condenser and an addition funnel were added 150 parts by mass of ethyl acetate, 20 parts by mass of acryloxyethyltrimethylammonium bis(trifluoromethanesulfonyl) imide (DMAEA-TFSI), 20 parts by mass of methoxy polyethylene glycol methacrylate having an average addition mole number of oxyethylene units: 23 (trade name: Blemmer PME-1000, manufactured by NOF Corporation), 60 parts by mass of 2-ethylhexyl acrylate, and 3.5 parts by mass of α-thioglycerol as a chain transfer agent. Then, the mixture was stirred at 70° C. for 1 hour under a nitrogen atmosphere and 0.2 parts by mass of 2,2′-azobisisobutyronitrile as a thermal polymerization initiator was added thereto. The mixture was allowed to react at 70° C. for 2 hours and then at 80° C. for 5 hours. The resulting (meth)acryl-based polymer (b2) was found to have an intrinsic viscosity of 0.041 (dL/g).

<Preparation of Polymer (B): (Meth)Acryl-Based Polymer (b3)>

To a four-necked flask equipped with a stirring blade, a thermometer, a nitrogen gas inlet tube, a condenser and an addition funnel were added 233 parts by mass of ethyl acetate, 20 parts by mass of acryloxyethyltrimethylammonium bis(trifluoromethanesulfonyl) imide (DMAEA-TFSI), 20 parts by mass of methoxy polyethylene glycol methacrylate having an average addition mole number of oxyethylene units: 23 (trade name: Blemmer PME-1000, manufactured by NOF Corporation), 60 parts by mass of 2-ethylhexyl acrylate, and 3.5 parts by mass of methyl thioglycolate as a chain transfer agent. Then, the mixture was stirred at 70° C. for 1 hour under a nitrogen atmosphere and 0.2 parts by mass of 2,2′-azobisisobutyronitrile as a thermal polymerization initiator was added thereto. The mixture was allowed to react at 70° C. for 2 hours and then at 80° C. for 5 hours. The resulting (meth)acryl-based polymer (b3) was found to have an intrinsic viscosity of 0.039 (dL/g).

<Preparation of Polymer (B): (Meth)Acryl-Based Polymer (b4)>

To a four-necked flask equipped with a stirring blade, a thermometer, a nitrogen gas inlet tube, a condenser and an addition funnel were added 150 parts by mass of ethyl acetate, 20 parts by mass of (3-acrylamidopropyl)trimethylammonium bis(trifluoromethanesulfonyl)imide (DMAPAA-TFSI), 20 parts by mass of methoxy polyethylene glycol methacrylate having an average addition mole number of oxyethylene units: 23 (trade name: Blemmer PME-1000, manufactured by NOF Corporation), 60 parts by mass of 2-ethylhexyl acrylate, and 3.5 parts by mass of α-thioglycerol as a chain transfer agent. Then, the mixture was stirred at 70° C. for 1 hour under a nitrogen atmosphere and 0.2 parts by mass of 2,2′-azobisisobutyronitrile as a thermal polymerization initiator was added thereto. The mixture was allowed to react at 70° C. for 2 hours and then at 80° C. for 5 hours. The resulting (meth)acryl-based polymer (b4) was found to have an intrinsic viscosity of 0.045 (dL/g).

<Preparation of Polymer (B): (Meth)Acryl-Based Polymer (b5)>

To a four-necked flask equipped with a stirring blade, a thermometer, a nitrogen gas inlet tube, a condenser and an addition funnel were added 233 parts by mass of ethyl acetate, 20 parts by mass of (3-acrylamidopropyl)trimethylammonium bis(trifluoromethanesulfonyl)imide (DMAPAA-TFSI), 20 parts by mass of methoxy polyethylene glycol methacrylate having an average addition mole number of oxyethylene units: 23 (trade name: Blemmer PME-1000, manufactured by NOF Corporation), 60 parts by mass of 2-ethylhexyl acrylate, and 3.5 parts by mass of methyl thioglycolate as a chain transfer agent. Then, the mixture was stirred at 70° C. for 1 hour under a nitrogen atmosphere and 0.2 parts by mass of 2,2′-azobisisobutyronitrile as a thermal polymerization initiator was added thereto. The mixture was allowed to react at 70° C. for 2 hours and then at 80° C. for 5 hours. The resulting (meth)acryl-based polymer (b5) was found to have an intrinsic viscosity of 0.043 (dL/g).

### Example 1

### Preparation of Pressure-Sensitive Adhesive Composition

The (meth)acryl-based polymer (a) solution (35% by mass) was diluted to 20% by mass with ethyl acetate. To 500 parts by mass (100 parts by mass as the polymer) of the resulting diluted solution were added 25 parts by mass (solid content: 40% by mass in ethyl acetate solution) of the (meth)acryl-based polymer (b1), 4.0 parts by mass of Coronate L (trimethylolpropane/tolylene diisocyanate trimer adduct, solid content of 75% by weight, in ethyl acetate solution, manufactured by Nippon Polyurethane Industry Co., Ltd.) as a crosslinking agent, and 3.0 parts by mass of dioctyltin dilaurate (1% by weight in ethyl acetate solution) as a crosslinking catalyst, and they were mixed with stirring at 25° C. for about 5 minutes, thereby to prepare a pressure-sensitive adhesive composition (1).

### Production of Pressure-Sensitive Adhesive Sheet

The pressure-sensitive adhesive composition (1) was applied to a surface opposite to the antistatic-treated surface of a polyethyleneterephthalate film (trade name: Diafoil T100G38, 38 μm thickness, manufactured by Mitsubishi Plastics, Inc.) with an antistatic-treated layer, and heated at 130° C. for 2 minutes to form a pressure-sensitive adhesive layer having a thickness of 15 μm.

Subsequently, a polyethylene terephthalate film having a thickness of 25 μm, on one side of which a silicone treatment had been performed, was bonded on the silicone-treated surface to the surface of the pressure-sensitive adhesive layer to prepare a pressure-sensitive adhesive sheet.

### Example 2

### Preparation of Pressure-Sensitive Adhesive Composition

A pressure-sensitive adhesive composition (2) was prepared in the same way as in Example 1, except that 3.8 parts by mass of the (meth)acryl-based polymer (b2) (solid content: 40% by mass in ethyl acetate solution) were used in place of 25 parts by mass of the (meth)acryl-based polymer (b1) (solid content: 40% by mass in ethyl acetate solution).

### Production of Pressure-Sensitive Adhesive Sheet

A pressure-sensitive adhesive sheet was produced in the same way as in Example 1, except that the pressure-sensitive adhesive composition (2) was used in place of the pressure-sensitive adhesive composition (1).

### Example 3

### Preparation of Pressure-Sensitive Adhesive Composition

A pressure-sensitive adhesive composition (3) was prepared in the same way as in Example 1, except that 8.3 parts by mass of the (meth)acryl-based polymer (b3) (solid content: 30% by mass in ethyl acetate solution) were used in place of 25 parts by mass of the (meth)acryl-based polymer (b1) (solid content: 40% by mass in ethyl acetate solution).

### Production of Pressure-sensitive Adhesive Sheet

A pressure-sensitive adhesive sheet was produced in the same way as in Example 1, except that the pressure-sensitive adhesive composition (3) was used in place of the pressure-sensitive adhesive composition (1).

### Example 4

### Preparation of Pressure-Sensitive Adhesive Composition

A pressure-sensitive adhesive composition (4) was prepared in the same way as in Example 1, except that 12.5 parts by mass of the (meth)acryl-based polymer (b2) (solid content: 40% by mass in ethyl acetate solution) were used in place of 25 parts by mass of the (meth)acryl-based polymer (b1) (solid content: 40% by mass in ethyl acetate solution).

### Production of Pressure-sensitive Adhesive Sheet

A pressure-sensitive adhesive sheet was produced in the same way as in Example 1, except that the pressure-sensitive adhesive composition (4) was used in place of the pressure-sensitive adhesive composition (1).

### Example 5

### Preparation of Pressure-sensitive Adhesive Composition

A pressure-sensitive adhesive composition (5) was prepared in the same way as in Example 1, except that 12.5 parts by mass of the (meth)acryl-based polymer (b2) (solid content: 40% by mass in ethyl acetate solution) were used in place of 25 parts by mass of the (meth)acryl-based polymer (b1) (solid content: 40% by mass in ethyl acetate solution), and 3.0 parts by mass of Coronate HX (an isocyanurate type hexamethylene diisocyanate-based crosslinking agent, manufactured by Nippon Polyurethane Industry Co., Ltd.) were used in place of 4.0 parts by mass of Coronate L (trimethylolpropane/tolylenediisocyanate trimer adduct, solid content: 75% by weight in ethyl acetate solution, manufactured by Nippon Polyurethane Industry Co., Ltd.).

### Production of Pressure-sensitive Adhesive Sheet

A pressure-sensitive adhesive sheet was produced in the same way as in Example 1, except that the pressure-sensitive adhesive composition (5) was used in place of the pressure-sensitive adhesive composition (1).

### Example 6

### Preparation of Pressure-sensitive Adhesive Composition

A pressure-sensitive adhesive composition (6) was prepared in the same way as in Example 1, except that 12.5 parts by mass of the (meth)acryl-based polymer (b4) (solid content: 40% by mass in ethyl acetate solution) was used in place of 25 parts by mass of the (meth)acryl-based polymer (b1) (solid content: 40% by mass in ethyl acetate solution), and 3.0 parts by mass of Coronate HX (an isocyanurate type hexamethylene diisocyanate-based crosslinking agent, manufactured by Nippon Polyurethane Industry Co., Ltd.) were used in place of 4.0 parts by mass of Coronate L (trimethylolpropane/tolylenediisocyanate trimer adduct, solid content: 75% by mass in ethyl acetate solution, manufactured by Nippon Polyurethane Industry Co., Ltd.).

### Production of Pressure-sensitive Adhesive Sheet

A pressure-sensitive adhesive sheet was produced in the same way as in Example 1, except that the pressure-sensitive adhesive composition (6) was used in place of the pressure-sensitive adhesive composition (1).

### Example 7

### Preparation of Pressure-sensitive Adhesive Composition

A pressure-sensitive adhesive composition (7) was prepared in the same way as in Example 1, except that 16.7 parts by mass of the (meth)acryl-based polymer (b3) (solid content: 30% by mass in ethyl acetate solution) were used in place of 25 parts by mass of the (meth)acryl-based polymer (b1) (solid content: 40% by mass in ethyl acetate solution).

### Production of Pressure-sensitive Adhesive Sheet

A pressure-sensitive adhesive sheet was produced in the same way as in Example 1, except that the pressure-sensitive adhesive composition (7) was used in place of the pressure-sensitive adhesive composition (1).

### Example 8

### Preparation of Pressure-sensitive Adhesive Composition

A pressure-sensitive adhesive composition (8) was prepared in the same way as in Example 1, except that 16.7 parts by mass of the (meth)acryl-based polymer (b5) (solid content: 30% by mass in ethyl acetate solution) were used in place of 25 parts by mass of the (meth)acryl-based polymer (b1) (solid content: 40% by mass in ethyl acetate solution).

### Production of Pressure-sensitive Adhesive Sheet

A pressure-sensitive adhesive sheet was produced in the same way as in Example 1, except that the pressure-sensitive adhesive composition (8) was used in place of the pressure-sensitive adhesive composition (1).

### Example 9

### Preparation of Pressure-sensitive Adhesive Composition

A pressure-sensitive adhesive composition (9) was prepared in the same way as in Example 1, except that 33.3 parts by mass of the (meth)acryl-based polymer (b5) (solid content: 30% by mass in ethyl acetate solution) were used in place of 25 parts by mass of the (meth)acryl-based polymer (b1) (solid content: 40% by mass in ethyl acetate solution).

### Production of Pressure-sensitive Adhesive Sheet

A pressure-sensitive adhesive sheet was produced in the same way as in Example 1, except that the pressure-sensitive adhesive composition (9) was used in place of the pressure-sensitive adhesive composition (1).

### Example 10

### Preparation of Pressure-sensitive Adhesive Composition

A pressure-sensitive adhesive composition (10) was prepared in the same way as in Example 1, except that 62.5 parts by mass of the (meth)acryl-based polymer (b4) (solid content: 40% by mass in ethyl acetate solution) were used in place of 25 parts by mass of the (meth)acryl-based polymer (b1) (solid content: 40% by mass in ethyl acetate solution).

### Production of Pressure-sensitive Adhesive Sheet

A pressure-sensitive adhesive sheet was produced in the same way as in Example 1, except that the pressure-sensitive adhesive composition (10) was used in place of the pressure-sensitive adhesive composition (1).

### Comparative Example 1

### Preparation of Pressure-sensitive Adhesive Composition

The (meth)acryl-based polymer (a) solution (35% by mass) was diluted to 20% by mass with ethyl acetate. To 500 parts by mass (100 parts by mass as the polymer) of the resulting diluted solution were added 0.06 parts by mass of an alkali metal salt, lithiumbis(trifluoromethanesulfonyl) imide (LiTFSI), 0.5 parts by mass of a polyether compound having a polyalkylene glycol chain (KF6004, manufactured by Shin-Etsu Chemical Co., Ltd.), 3.3 parts by mass of Coronate L (trimethylolpropane/tolylene diisocyanate trimer adduct, solid content: 75% by weight in ethyl acetate solution, manufactured by Nippon Polyurethane Industry Co., Ltd.) as a crosslinking agent, and 3.0 parts by mass of dioctyltin dilaurate (1% by weight in ethyl acetate solution) as a crosslinking catalyst, and they were mixed with stirring at 25° C. for about 5 minutes, thereby to prepare a pressure-sensitive adhesive composition (11).

### Production of Pressure-sensitive Adhesive Sheet

A pressure-sensitive adhesive sheet was produced in the same way as in Example 1, except that the pressure-sensitive adhesive composition (11) was used in place of the pressure-sensitive adhesive composition (1).

### Comparative Example 2

### Preparation of Pressure-sensitive Adhesive Composition

The polymer (1) solution (35% by mass) for pressure-sensitive adhesives was diluted to 20% by mass with ethyl acetate. To 500 parts by mass (100 parts by mass as the polymer) of the resulting diluted solution were added 0.1 parts by mass of a non-reactive ionic liquid, 1-ethyl-3-methylimidazoliumbis(fluorosulfonyl)imide (AS-110, manufactured by Dai-ichi Kogyo Seiyaku Co., Ltd.), 3.3 parts by mass of Coronate L (trimethylolpropane/tolylenediisocyanate trimer adduct, solid content: 75% by weight in ethyl acetate solution, manufactured by Nippon Polyurethane Industry Co., Ltd.) as a crosslinking agent, and 3.0 parts by mass of dioctyltin dilaurate (1% by weight in ethyl acetate solution) as a crosslinking catalyst, and they were mixed with stirring at 25° C. for about 5 minutes, thereby to prepare a pressure-sensitive adhesive composition (12).

### Production of Pressure-sensitive Adhesive Sheet

A pressure-sensitive adhesive sheet was produced in the same way as in Example 1, except that the pressure-sensitive adhesive composition (12) was used in place of the pressure-sensitive adhesive composition (1).

TABLE 1

| | | | | | | | | | | | | | | | Pressure- |
|---|---|---|---|---|---|---|---|---|---|---|---|---|---|---|---|
| | Polymer (A) | | | | | Polymer (B) | | | | | | Crosslinking | | Gel | sensitive |
| | Poly- | | | | | Poly- | | Intrinsic | | | | agent | | fraction | adhesive |
| | mer | Compo- | Tg | | | mer | Compo- | viscosity | | Additive | | C/L | C/HX | [% by | thickness |
| | used | sition | [° C.] | Mw | Parts | used | sition | [dL/g] | Parts | Kind | Parts | Parts | Parts | mass] | [μm] |
| Example 1 | (a) | 2EHA/ | −68 | 550,000 | 100 | (b1) | DMAEA- | 0.032 | 10 | — | — | 3 | — | 89.3 | 15 |
| | | HEA = | | | | | TFSI/ | | | | | | | | |
| | | 96/4 | | | | | 2EHA = | | | | | | | | |
| | | | | | | | 20/80 | | | | | | | | |
| Example 2 | (a) | 2EHA/ | −68 | 550,000 | 100 | (b2) | DMAEA- | 0.041 | 1.5 | — | — | 3 | — | 95.5 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Example 3 | (a) | 2EHA/ | −68 | 550,000 | 100 | (b3) | DMAEA- | 0.039 | 2.5 | — | — | 3 | — | 93.5 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Example 4 | (a) | 2EHA/ | −68 | 550,000 | 100 | (b2) | DMAEA- | 0.041 | 5 | — | — | 3 | — | 92.4 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Example 5 | (a) | 2EHA/ | −68 | 550,000 | 100 | (b2) | DMAEA- | 0.041 | 5 | — | — | — | 3 | 93.7 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Example 6 | (a) | 2EHA/ | −68 | 550,000 | 100 | (b4) | DMAPAA- | 0.045 | 5 | — | — | — | 3 | 93.0 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Example 7 | (a) | 2EHA/ | −68 | 550,000 | 100 | (b3) | DMAEA- | 0.039 | 5 | — | — | 3 | — | 91.0 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Example 8 | (a) | 2EHA/ | −68 | 550,000 | 100 | (b5) | DMAPAA- | 0.043 | 5 | — | — | 3 | — | 91.5 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Example 9 | (a) | 2EHA/ | −68 | 550,000 | 100 | (b5) | DMAPAA- | 0.043 | 10 | — | — | 3 | — | 86.7 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Example 10 | (a) | 2EHA/ | −68 | 550,000 | 100 | (b4) | DMAPAA- | 0.045 | 25 | — | — | 3 | — | 76.3 | 15 |
| | | HEA = | | | | | TFSI/ | | | | | | | | |
| | | 96/4 | | | | | PME1000/ | | | | | | | | |
| | | | | | | | 2EHA = | | | | | | | | |
| | | | | | | | 20/20/60 | | | | | | | | |
| Comparative | (a) | 2EHA/ | −68 | 550,000 | 100 | — | — | — | — | LiTFSI | 0.1 | 2.5 | — | 94.4 | 15 |
| Example 1 | | HEA = | | | | | | | | KF6004 | 0.5 | | | | |
| | | 96/4 | | | | | | | | | | | | | |
| Comparative | (a) | 2EHA/ | −68 | 550,000 | 100 | — | — | — | — | AS-110 | 0.1 | 2.5 | — | 95.8 | 15 |
| Example 2 | | HEA = | | | | | | | | | | | | | |
| | | 96/4 | | | | | | | | | | | | | |

The abbreviations in Table 1 represent the following compounds. Note that “parts” described in Table 1 represent a solid content.

2EHA: 2-Ethylhexyl acrylate

HEA: 2-Hydroxyethyl acrylate

DMAEA-TFSI: 2-(Acryloyloxy)ethyltrimethylammonium bis(trifluoromethanesulfonyl)imide (reactive ionic liquid)

DMAPAA-TFSI: (3-Acrylamidopropyl)trimethylammonium bis(trifluoromethanesulfonyl)imide (reactive ionic liquid)

PME 1000: Methoxy-terminated polyethylene glycol methacrylate (average addition mole number of ethylene oxide: 23) (alkylene oxide group-containing reactive monomer)

AS-110:1-Ethyl-3-methylimidazolium bis(fluorosulfonyl)imide (non-reactive ionic liquid)

LiTFSI: Lithium bis(trifluoromethanesulfonyl)imide (alkali metal salt)

KF6004: Polyoxyalkylene-modified polydimethylsiloxane (polyether compound)

C/L (Coronate L): Trimethylolpropane/tolylene diisocyanate trimer adduct (crosslinking agent)

C/HX (Coronate HX): Isocyanurate type hexamethylene diisocyanate (crosslinking agent)

### (Measurement Method and Evaluation Method)

### <Measurement of Molecular Weight>

The weight average molecular weight (Mw) of the polymer (A) was measured by using a GPC apparatus (HLC-8220 GPC, manufactured by Tosoh Corporation). The measurement was performed under the following conditions. Note that the molecular weight was determined in terms of polystyrene standard.

The measurement results are shown in Table 1.

Sample concentration: 0.2% by mass (tetrahydrofuran (THF) solution)

Sample injection amount: 10

Eluent: THF

Flow rate: 0.6 ml/min

Measurement temperature: 40° C.

Columns:

Sample column: TSK guard column Super HZ-H (1 column)+TSK gel Super HZM-H (2 columns)

Reference column: TSK gel Super H-RC (1 column)

Detector: differential refractometer (RI)

### [Measurement of Intrinsic Viscosity>

The intrinsic viscosity (dL/g) of the polymer (B) was measured in accordance with the method described in JIS-K7367-1. The measurement conditions are shown below and the measurement results are shown in Table 1.

Sample concentration: Three kinds of sample solutions were prepared within a range of 0.1 to 0.6 g/dL.

Solvent: Ethyl acetate

Measurement temperature: 25° C.

Apparatus: Automatic viscometer for capillary viscosity manufactured by Shibayama Scientific Co., Ltd.)

Viscosity tube: Ubbelohde type #1

### <Measurement of Gel Fraction (Ratio of Solvent-Insoluble Component)>

A ratio of a solvent-insoluble component (gel fraction) was determined in the following way: after 0.1 g of a pressure-sensitive adhesive layer was sampled and precisely weighed (mass before dipping), this sample was dipped in approximately 50 ml of ethyl acetate at room temperature (20 to 25° C.) for 1 week; a solvent (ethyl acetate) insoluble portion was taken out, dried at 130° C. for 2 hours, and then weighed (mass after dipping and drying); and the ratio was calculated by using an equation for calculating the gel fraction (ratio of solvent-insoluble components). The measurement results are shown in Table 1.

Gel fraction (mass %)=[(mass after dipping and drying)/(mass before dipping)]×100 (5)

### <Low-Speed Peeling Test: 180° Peeling Adhesive Strength>

The pressure-sensitive adhesive sheet according to each of Examples and Comparative Examples was cut into a piece having a size of 25 mm in width×100 mm in length. After the release liner was peeled off, the sheet was pressure-bonded, with a hand roller, to the surface of a triacetyl cellulose polarizing plate (SEG 1425 DU, width: 70 mm, length: 100 mm, manufactured by Nitto Denko Corporation) and then laminated under pressure-bonding conditions of 0.25 MPa and 0.3 m/min, thereby producing an evaluation sample (an optical film with an antistatic pressure-sensitive adhesive sheet).

After the lamination, the sample was left to stand under an environment of 23° C. and 50% RH for 30 minutes. The other surface of the triacetylcellulose polarizing plate was fixed to an acrylic plate with a double-sided pressure-sensitive adhesive tape, and the adhesive strength occurring when one end of the pressure-sensitive adhesive sheet was peeled off with a versatile tensile tester under conditions of a tensile speed of 0.3 m/min and a peeling angle of 180° was measured. The measurement was performed under an environment of 23° C. and 50% RH. The case where the adhesive strength occurring at low-speed peeling was 0.04 N/25 mm or more was evaluated as good, while the case where the adhesive strength occurring at low-speed peeling was less than 0.04 N/25 mm was evaluated as bad. The measurement results are shown in Table 2.

### <High-Speed Peeling Test: 180° Peeling Adhesive Strength>

The pressure-sensitive adhesive sheet according to each of Examples and Comparative Examples was cut into a piece having a size of 25 mm in width×100 mm in length. After the release liner was peeled off, the sheet was pressure-bonded, with a hand roller, to the surface of a triacetyl cellulose polarizing plate (SEG 1425 DU, width: 70 mm, length: 100 mm, manufactured by Nitto Denko Corporation) and then laminated under pressure-bonding conditions of 0.25 MPa and 0.3 m/min, thereby producing an evaluation sample (an optical film with an antistatic pressure-sensitive adhesive sheet).

After the lamination, the sample was left to stand under an environment of 23° C.×50% RH for 30 minutes. The other surface of the triacetylcellulose polarizing plate was fixed to an acrylic plate with a double-sided pressure-sensitive adhesive tape, and the adhesive strength occurring when one end of the pressure-sensitive adhesive sheet was peeled off with a versatile tensile tester under conditions of a tensile speed of 30 m/min and a peeling angle of 180° was measured. The measurement was performed under an environment of 23° C. and 50% RH. The case where the adhesive strength occurring at high-speed peeling was 10 N/25 mm or less was evaluated as good, while the case where the adhesive strength occurring at high-speed peeling exceeds 10 N/25 mm was evaluated as bad. The measurement results are shown in Table 2.

### <Measurement of Peeling Electrification Voltage>

A pressure-sensitive adhesive sheet 2 was cut into apiece with a size of 70 mm in width and 130 mm in length, and the separator was peeled off. Using a hand roller, the piece was then press-bonded to the surface of a polarizing plate 3 (SEG1425DU, 70 mm in width and 100 mm in length, manufactured by Nitto Denko Corporation), which had been bonded to an acrylic plate 4 (ACRYLITE, 1 mm in thickness, 70 mm in width, and 100 mm in length, manufactured by Mitsubishi Rayon Co., Ltd.) having undergone static elimination in advance, in such a manner that one end of the piece protruded 30 mm out of the plate.

The resulting sample was left to stand in an environment of 23° C. and 50% RH for 1 day and then set at a predetermined location of a sample-fixing base 5 as shown in FIG. 2. The one end protruding 30 mm was fixed to an automatic winder, and the piece was peeled off at a peel angle of 150° and a peel rate of 10 m/minute. The potential generated on the surface of the polarizing plate in this process was measured using a potential meter 1 (KSD-0103, manufactured by Kasuga Electric Works Ltd.) fixed at a predetermined position, and used as the peeling electrification voltage value. The measurement was performed in an environment of 20° C. and 25% RH or 23° C. and 50% RH. The absolute value of 1.0 kV or less of the peeling electrification voltage was evaluated as good and the absolute value exceeding 1.0 kV was evaluated as bad. The measurement results are shown in Table 2.

### <Transparency Test: Initial Haze>

The pressure-sensitive adhesive sheet according to each of Examples and Comparative Examples was cut into a piece having a size of 50 mm in width×50 mm in length. After the release liner was peeled off, a haze was measured by using a haze meter (manufactured by Murakami Color Research Laboratory Co., Ltd.). The case where the haze was less than 10% was evaluated as good, while the case where the haze was 10% or more was evaluated as bad. The measurement results are shown in Table 2.

TABLE 2

| | Evaluation results | | | |
|---|---|---|---|---|
| | Peeling | 180° peeling | | |
| | electrification | adhesive strength | | |
| | voltage | Tensile speed | Tensile speed | Trans- |
| | 23° C. × 50% | 0.3 m/min | 30 m/min | parency |
| | RH After 1 day | (low speed) | (high speed) | Haze |
| Unit | kV | N/25 mm | N/25 mm | % |
| Example 1 | −0.3 | 0.13 | 1.98 | 2.0 |
| Example 2 | −0.6 | 0.10 | 1.95 | 2.4 |
| Example 3 | −0.3 | 0.06 | 1.62 | 3.0 |
| Example 4 | −0.2 | 0.10 | 1.55 | 2.9 |
| Example 5 | −0.1 | 0.06 | 1.10 | 2.0 |
| Example 6 | 0.0 | 0.06 | 1.15 | 2.1 |
| Example 7 | −0.1 | 0.06 | 2.03 | 2.8 |
| Example 8 | −0.2 | 0.06 | 1.98 | 2.1 |
| Example 9 | 0.0 | 0.06 | 2.53 | 2.9 |
| Example 10 | 0.0 | 0.32 | 7.90 | 3.4 |
| Comparative | 0.0 | 0.03 | 0.45 | 2.2 |
| Example 1 | | | | |
| Comparative | −1.2 | 0.17 | 2.83 | 2.0 |
| Example 2 | | | | |

As shown in Table 2, when the pressure-sensitive adhesive sheets (antistatic pressure-sensitive adhesive sheets) produced according to the present invention (Examples 1 to 10) were used, it was confirmed that they showed a peeling electrification voltage of within a range of ±1.0 kV, an excellent antistatic property, an adhesive strength being within a desired range at low-speed peeling and high-speed peeling, an excellent repeeling property, and an excellent adhesive property, and further a satisfactory transparency.

In contrast, in Comparative Example 1, because a lithium salt and a polyether compound were used as additives (antistatic agents), but the polymer (B) was not used, the adhesive strength at low-speed peeling was insufficient though an antistatic property was obtained. In addition, in Comparative Example 2, because a small amount of a non-reactive ionic liquid was used as an additive (antistatic agent) and the polymer (B) was not used, an antistatic property was insufficient in comparison with Examples, though the adhesive strength at low-speed peeling was sufficient.

### DESCRIPTION OF REFERENCE SIGNS

1 Potential meter
2 Pressure-sensitive adhesive sheet
3 Polarizing plate
4 Acrylic plate
5 Sample-fixing base
10 Pressure-sensitive adhesive sheet (Antistatic pressure-sensitive adhesive sheet)
11 Separator
12 Pressure-sensitive adhesive layer
13 Substrate film

1. A pressure-sensitive adhesive composition comprising:
a polymer (A) having a glass transition temperature of lower than 0° C.; and
a polymer (B) containing a reactive ionic liquid as a monomer unit and having an intrinsic viscosity (dL/g) of 0.01 or more and less than 0.5.

2. The pressure-sensitive adhesive composition according to claim 1, wherein 0.05 to 30 parts by mass of the polymer (B) is contained, based on 100 parts by mass of the polymer (A).

3. The pressure-sensitive adhesive composition according to claim 1, wherein the polymer (B) is a (meth)acryl-based polymer.

4. The pressure-sensitive adhesive composition according to claim 1, wherein the polymer (B) contains, as a monomer unit, a monomer having a polyoxyalkylene skeleton.

5. The pressure-sensitive adhesive composition according to claim 1, wherein the reactive ionic liquid is a reactive ionic liquid represented by the following general formula (1) and/or (2):
CH₂═C(R¹)COOZX⁺Y⁻ (1)
CH₂═C(R¹)CONHZX⁺Y⁻ (2)
[In the formulae (1) and (2), R¹ is a hydrogen atom or a methyl group, X⁺ is a cation moiety, and Y⁻ is an anion. Z represents an alkylene group of 1 to 3 carbon atoms].

6. The pressure-sensitive adhesive composition according to claim 5, wherein the cation moiety is a quaternary ammonium group.

7. The pressure-sensitive adhesive composition according to claim 5, wherein the anion is a fluorine-containing anion.

8. The pressure-sensitive adhesive composition according to claim 4, wherein the monomer having a polyoxyalkylene skeleton is an alkylene oxide group-containing reactive monomer having an average addition mole number of 3 to 100 of the oxyalkylene units.

9. A pressure-sensitive adhesive layer formed of the pressure-sensitive adhesive composition according to claim 1.

10. The pressure-sensitive adhesive layer according to claim 9, wherein the gel fraction is 85.00 to 99.95% by mass.

11. A pressure-sensitive adhesive sheet, wherein the pressure-sensitive adhesive layer according to claim 9 is formed on at least one side of a substrate film.

12. The pressure-sensitive adhesive sheet according to claim 11, wherein the substrate film is a plastic film.

13. The pressure-sensitive adhesive sheet according to claim 11, wherein the pressure-sensitive adhesive sheet is used for surface protection.

14. The pressure-sensitive adhesive sheet according to claim 11, wherein the pressure-sensitive adhesive sheet is used for production process and shipment process of electronic parts.

15. An optical film with a pressure-sensitive adhesive sheet, wherein the pressure-sensitive adhesive sheet according to claim 13 is bonded to an optical film.
